(19) United States
(12) Patent Application Publication
(10) Pub. No.: US 2017/0183094 A1
(43) Pub. Date: Jun. 29, 2017

(54) Convertible Payload Transport Aircraft

(71) Applicant: Thomas McNally, Philadelphia, PA (US)

(72) Inventor: Thomas McNally, Philadelphia, PA (US)

(21) Appl. No.: 15/309,539

(22) PCT Filed: Apr. 24, 2015
(86) PCT No.: PCT/US2015/027557

§ 371 Date: Nov. 8, 2016

Related U.S. Application Data
(60) Provisional application No. 61/990,382, filed on May 8, 2014.

(51) Int. Cl. B64C 37/00; B64D 9/00; B64C 39/08; B64C 25/04; B64C 39/02

(52) U.S. Cl. CPC B64C 37/00; B64C 25/04; B64C 39/02; B64C 39/08; B64D 9/003

(57) ABSTRACT

A convertible payload transport aircraft (100, 400) is provided that includes a main body having a cockpit (112), a first fixed wing (120) extending from a side of the cockpit (112) and a second fixed wing (120) extending from the opposing side of the cockpit (112). The aircraft (100, 400) also includes a first pair of wheel struts (124) extending between the first fixed wing (120) and a first set of corresponding wheels (128), a second pair of wheel struts (124) extending between the second fixed wing (120) and a second set of corresponding wheels (128), wheel-strut cables (126) that extend between the first pair of wheel struts (124), the second pair of wheel struts (124) and the main body and a payload interface system (102) disposed under the cockpit (112) and between the wheel struts (124) and configured to be coupled to a payload. The aircraft may also include a mast system (106, 406) and a para-wing (404) coupled to the mast system (406) configured to facilitate transport of heavier payloads.

### CROSS-REFERENCE TO RELATED APPLICATIONS

This application claims priority to U.S. provisional application Ser. No. 61/990,382 filed May 8, 2014, which is incorporated herein by reference in its entirety.

### TECHNOLOGY FIELD

The present application relates generally to an aircraft for transporting payloads, and in particular, to a convertible aircraft for transporting large intermodal shipping containers.

### BACKGROUND

The shipping industry employs and transports various standard intermodal shipping-containers (International Organization of Standards (ISO) shipping-containers) for storage and transport of materials and products around the world. Intermodal indicates that the containers may be transferred from one mode of transport to another without unloading and reloading the contents of the container, reducing cargo handling and thereby improving security, reducing damage and loss, and allowing for faster, more direct transport.

Conventional modes of transporting ISO intermodal shipping containers include ship, rail, and truck. Some areas of the world, however, are not adequately accessible or accessible at all by ship, rail, or truck. Further, even with adequate infrastructure, it may take days or longer to transport ISO containers by ship, rail, and truck. Although conventional transport aircraft can travel much faster and more directly than ship, train, and truck, conventional transport aircraft are not fitted for the transport of heavy semi-trailers nor ISO intermodal shipping-containers.

### SUMMARY

Embodiments provide a convertible payload transport aircraft (CPTA) that includes a main body including a cockpit, a first fixed wing extending in a first direction from a side of the cockpit and a second fixed wing extending in a second direction from an opposing side of the cockpit. The aircraft also includes a first pair of wheel struts extending between the first fixed wing and a first set of corresponding wheels and a second pair of wheel struts extending between the second fixed wing and a second set of corresponding wheels. The aircraft also includes a plurality of wheel-strut cables that extend between the first pair of wheel struts, the second pair of wheel struts and the main body and a payload interface system disposed under the cockpit and between the first pair of wheel struts and the second pair of wheel struts and configured to be coupled to a payload.

According to one embodiment, the convertible payload transport aircraft further includes a mast system comprising a main front fixed para-wing mast extending from a top of the main body, a first side front fixed para-wing mast extending from a top of the first fixed wing and a second side front fixed para-wing mast extending from a top of the second fixed wing. The mast system also includes a first rear moveable para-wing mast extending from a top of the first fixed wing and a second rear moveable para-wing mast extending from a top of the second fixed wing. The mast system also includes a first mast spacer extending between the main front fixed para-wing mast and the first side front fixed para-wing mast and a second mast spacer extending between the main front fixed para-wing mast and the second side front fixed para-wing mast. The mast further includes a plurality of mast cables configured to secure the mast system to the main body and a para-wing coupled to the mast system and configured to facilitate transport of the payload.

According to an aspect of the embodiment, the para-wing further includes upper and lower fabric surfaces, a plurality of flexible ribs extending between the upper and lower fabric surfaces, a plurality of rigid ribs extending between the upper and lower fabric surfaces, a plurality of pockets, each of the pockets configured to hold one of the plurality of rigid ribs, leading edge ram-air inflation ports, a plurality of riser lines and mast coupling elements configured to couple the para-wing to the mast system and internal spar-rod rib spacers configured to space the plurality of rigid ribs equally apart from each other.

According to another embodiment, the payload interface system is a top lift payload interface system including a plurality of movable engaging elements extending from the main body and a rack. The rack includes a plurality of cross supports. Each cross support extends a width between the first pair of wheel struts and the second pair of wheel struts. The rack also includes a pair of opposing side supports, each side support extending a length substantially perpendicular to the width and a plurality of teeth spaced from each other and extending from the pair of opposing side supports. The plurality of teeth are configured to receive the plurality of engaging elements within spaces between the plurality of teeth and the plurality of movable engaging elements are configured to lower the rack from the main body and raise the rack toward the main body.

In one embodiment, the top lift payload interface system is configured to adjust the payload along the length of the pair of opposing side supports. In an aspect of the embodiment, the convertible payload transport aircraft further includes a first fairing disposed at one end of the rack and a second fairing disposed at an opposite end of the rack. The fairings are configured to: (i) open to facilitate loading and unloading of the payload; and (ii) close to facilitate enhanced aerodynamics during flight. In another aspect of the embodiment, the top lift payload interface system further includes a container engagement system configured to secure the payload to the rack.

In another embodiment, the payload interface system is a drive-through payload interface system that includes a plurality of movable engaging elements extending from the main body and a payload holding compartment configured to receive the payload. The payload holding compartment includes a top rack having: (i) a plurality of cross supports extending a width between the first pair of struts and the second pair of struts; (ii) a pair of opposing side supports extending a length substantially perpendicular to the width; and (ii) a plurality of teeth spaced from each other, extending from the pair of opposing side supports and configured to receive the plurality of engaging elements extending from the main body to secure the payload to the main body. The payload holding compartment also includes a cargo deck having: (i) a plurality of cross supports extending a width between the first pair of struts and the second pair of struts; and (ii) a pair of opposing side supports extending a length substantially perpendicular to the width. The payload holding compartment further includes a pair of opposing side walls extending between the top rack and the cargo deck. The plurality of movable engaging elements are configured to lower the payload holding compartment from the main body and raise the payload holding compartment toward the main body.

In an aspect of an embodiment, the payload holding compartment further includes a main compartment body and expandable bellows disposed at opposing ends of the main compartment body, the expandable bellows configured to expand and retract to facilitate payloads of different sizes.

In another aspect of an embodiment, the payload holding compartment further includes a first fairing disposed at one end of the payload holding compartment and a second fairing disposed at an opposite end of the payload holding compartment. The fairings are configured to: (i) open to facilitate loading of the payload into the holding compartment and unloading of the payload from the payload holding compartment; and (ii) closed to provide enhanced aerodynamics.

In yet another aspect of an embodiment, the payload holding compartment further includes a plurality of columns extending between the top rack and the cargo deck and configured to provide load paths to distribute a load exerted by the payload from the cargo deck to the top rack.

According to one embodiment, the convertible payload transport aircraft further includes a plurality of riser lines coupled between the plurality of ribs and the first wing and between the plurality of ribs and the second fixed wing.

According to another embodiment, the convertible payload transport aircraft further includes pivotable latches coupled to the first pair of wheel struts and the second pair of wheel struts and configured to pivot between upright standby positions and engaged locked positions to limit or prevent movement of the payload.

Embodiments provide a convertible payload transport aircraft that includes a main body including a cockpit, a pair of fixed wings extending in opposite directions from the cockpit and a plurality of wheel struts extending between the pair of fixed wings and corresponding wheels. The aircraft also includes a top lift payload interface system disposed under the cockpit and configured to be coupled to a payload, the payload interface system that includes a plurality of movable engaging elements extending from the main body and a rack having: (i) a plurality of cross supports extending widthwise; (ii) a pair of opposing side supports extending lengthwise substantially perpendicular to the width; and (iii) a plurality of teeth spaced from each other and extending from the pair of opposing side supports. The plurality of teeth are configured to receive the plurality of engaging elements within spaces between the plurality of teeth and the plurality of movable engaging elements are configured to lower the rack from the main body and raise the rack toward the main body.

According to one embodiment, the top lift payload interface system is configured to adjust the payload along the length of the pair of opposing side supports.

According to another embodiment, the convertible payload transport aircraft further includes a first fairing disposed at one end of the rack and a second fairing disposed at an opposite end of the rack. The first fairing and the second fairing are configured to: (i) open to facilitate loading and unloading of the payload; and (ii) closed to facilitate enhanced aerodynamics during flight.

In another embodiment, the top lift payload interface system further includes a container engagement system configured to secure the payload to the rack.

Embodiments provide a convertible payload transport aircraft that includes a main body including a cockpit, a pair of fixed wings extending in opposite directions from the cockpit and a plurality of wheel struts extending between the pair of wings and corresponding wheels. The aircraft also includes a drive-through payload interface system disposed under the cockpit and configured to be coupled to a payload, the payload interface system that includes a plurality of movable engaging elements extending from the main body; and a drive through payload holding compartment configured to receive the payload. The drive through payload holding compartment includes a top rack having: (i) a plurality of cross supports extending a width between the first pair of wheel struts and the second pair of wheel struts; (ii) a pair of opposing side supports extending a length substantially perpendicular to the width; and (iii) a plurality of teeth spaced from each other, extending from the pair of opposing side supports and configured to receive the plurality of engaging elements extending from the main body to secure the payload to the main body. The drive through payload holding compartment also includes a cargo deck having: (i) a plurality of cross supports extending a width between the first pair of wheel struts and the second pair of wheel struts; and (ii) a pair of opposing side supports extending a length substantially perpendicular to the width. The drive through payload holding compartment further includes a pair of opposing side walls extending between the top rack and the cargo deck. The plurality of movable engaging elements are configured to lower the payload holding compartment from the main body and raise the payload holding compartment toward the main body.

In one embodiment, the convertible payload transport aircraft further includes a mast system that includes a main front fixed para-wing mast extending from a top of the main body, a first side front fixed para-wing mast extending from a top of one of the pair of fixed wing and a second side front fixed para-wing mast extending from a top of another of the pair of fixed wing. The mast system also includes a first rear moveable para-wing mast extending from a top of the one fixed wing, a second rear moveable para-wing mast extending from a top of the other fixed wins and a plurality of mast cables configured to secure the mast system to the main body. The aircraft also includes a para-wing coupled to the mast system and configured to facilitate transport of the payload.

According to an aspect of the embodiment, the para-wing further includes upper and lower fabric surfaces, a plurality of flexible ribs extending between the upper and lower fabric surfaces, a plurality of rigid ribs extending between the upper and lower fabric surfaces, a plurality of pockets, each of the pockets configured to hold one of the plurality of rigid ribs, leading edge ram-air inflation ports, a plurality of riser lines and mast coupling elements configured to couple the para-wing to the mast system and internal spar-rod rib spacers configured to space the plurality of rigid ribs equally apart from each other.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a perspective view of an exemplary convertible payload transport aircraft 100 according to an embodiments disclosed herein;

FIG. 2 is a perspective view of exemplary top lift payload interface system 102 shown in FIG. 1;

FIG. 3A is a wire drawing side view of the exemplary convertible payload transport aircraft 100 shown in FIG. 1;

FIG. 3B is a wire drawing front view of the exemplary convertible payload transport aircraft 100 shown in FIG. 1;

FIG. 4 is a side view of an exemplary convertible payload transport para-wing aircraft having a deployed removable para-wing and illustrating a drive-through payload interface system 402 according to embodiments disclosed herein;

FIG. 5A is a wire drawing front view of the exemplary convertible payload transport para-wing aircraft shown in FIG. 4 with a removable para-wing mast system erected but without the removable para-wing;

FIG. 5B is a wire drawing side view of the exemplary convertible payload transport para-wing aircraft shown in FIG. 4 with the removable para-wing mast system erected but without the removable para-wing;

FIG. 6 is a perspective cut-away view of the exemplary payload holding compartment shown in FIG. 4;

FIG. 7 is a perspective view of the exemplary convertible payload transport para-wing aircraft shown in FIG. 4;

FIG. 8 is a perspective view of a partially unzipped exemplary para-wing that may be used with embodiments disclosed herein;

FIG. 9 is a chart comparing specifications and performances of conventional aircrafts to exemplary aircrafts according to embodiments disclosed herein;

FIG. 10 shows various images of images of exemplary aircrafts according to embodiments described herein;

FIG. 11 is a perspective view of an exemplary aircraft having a payload holding compartment holding an ISO intermodal shipping container and showing riser lines and cable lines according to embodiments disclosed herein;

FIG. 12 is a side view of the exemplary aircraft shown in FIG. 1 a payload holding compartment holding an ISO intermodal shipping container according to embodiments disclosed herein;

FIG. 13 is a front view of the exemplary aircraft shown in FIG. 1 illustrating the container lifted up from the ground and wheel strut latches in an upright position according to embodiments disclosed herein;

FIG. 14 is a close-up perspective view of the exemplary top lift payload interface system shown in FIG. 1 and FIG. 2;

FIG. 15 is a side perspective view of the exemplary aircraft shown in FIG. 1 having a top lifted ISO intermodal shipping container in a secured position for transport and a truck pulling away from the aircraft according to embodiments disclosed herein;

FIG. 16 is a bottom perspective view of the exemplary top lift payload interface system shown in FIG. 1 and FIG. 2 holding an ISO intermodal shipping container and illustrating exemplary latches extending between wheel struts and the ISO intermodal shipping container according to embodiments disclosed herein;

FIG. 17 is a rear perspective view of an exemplary aircraft positioned over a payload holding compartment on a deck of a ship with a semi-trailer payload waiting to be moved within the payload holding compartment according to embodiments disclosed herein;

FIG. 18 is a front perspective view of the exemplary aircraft shown in FIG. 17 showing the payload within the semi-trailer payload holding compartment according to embodiments disclosed herein;

FIG. 19 shows the aircraft in FIG. 17 with the exemplary payload holding compartment in a position for transport according to embodiments disclosed herein;

FIG. 20 is a front perspective view of an exemplary aircraft with hooks coupled to the rack of the payload holding compartment resting on the ground and in position to receive a payload according to embodiments disclosed herein;

FIG. 21 is a perspective view of an exemplary aircraft with the para-wing deployed and securing a payload held within the payload holding compartment according to embodiments disclosed herein;

FIG. 22 is a wire drawing front view of the exemplary aircraft shown in FIG. 5A with the para-wing deployed;

FIG. 23 a wire drawing side view of the exemplary aircraft shown in FIG. 5B with the para-wing deployed;

FIG. 24 is a wire drawing illustrating a top view of the exemplary aircraft shown in FIG. 5A and FIG. 5B with the para-wing and mast system deployed;

FIG. 25 is a wire drawing front perspective view of an exemplary aircraft with the para-wing and mast system deployed and securing payload holding compartment;

FIG. 26 is a wire drawing perspective view of the exemplary aircraft shown in FIG. 1 without ISO shipping-container payload;

FIG. 27 is a perspective view of a para-wing section showing the trailing edge and bottom surface in a deployed position for use with embodiments disclosed herein;

FIG. 28 is a front perspective view of the para-wing shown in FIG. 27 in a pre-deployment position prior to a dynamic input or inflation according to embodiments disclosed herein;

FIG. 29 is a side perspective view of the para-wing shown in FIG. 27 and showing a cross-section air-foil shape of an enclosed outer rib of the para-wing according to embodiments disclosed herein;

FIG. 30 is a close-up view of a portion of a para-wing showing cable hooks configured to couple between the ribs of the para-wing and the para-wing mast system of aircraft shown in FIG. 4;

FIG. 31 is a close-up view of a portion of an unzipped para-wing showing internal components of the para-wing for use with embodiments disclosed herein;

FIG. 32 is a close-up view of a portion of the mast system shown in FIG. 4, FIG. 5A and FIG. 5B, showing the leading edge of the para-wing coupled to forward fixed para-wing masts and rear moveable para-wing masts according to embodiments disclosed herein;

FIG. 33 is a close-up perspective view of the mast system illustrating forward fixed para-wing masts, cables with tension adjustment turn-buckles according to embodiments disclosed herein;

FIG. 34 is a close-up perspective view of the mast system illustrating cables locking into the distal end of the tail boom according to embodiments disclosed herein;

FIG. 35 is a top perspective view of the aircraft shown in FIG. 4 illustrating the mast system without para-wing deployed according to embodiments disclosed herein;

FIG. 36 is a bottom perspective view of the aircraft shown in FIG. 1 illustrating wheel struts and cables for use with embodiments disclosed herein;

FIG. 37 is a close-up perspective view showing the cockpit and the payload interface system of the aircraft shown in FIG. 1 with an ISO intermodal shipping container;

FIG. 38 is a perspective view of aircraft shown in FIG. 4 holding the payload holding compartment with the payload within and a truck coupled to the payload according to embodiments disclosed herein;

FIG. 39 is a top perspective view of the aircraft shown in FIG. 4 with payload holding compartment at a position on the ground with fairings open to receive a payload according to embodiments disclosed herein;

FIG. 40 is a perspective view of aircraft shown in FIG. 1 in a stand-by position showing portions of the fixed wings folded down and the container proximate to the ground coupled to the top lift payload interface system according to embodiments disclosed herein; and

FIG. 41 show perspective views of a scaled down personal aircraft enclosed-cabin flying motorcycle with and without the convertible para-wing according to embodiments disclosed herein.

### DETAILED DESCRIPTION OF EXEMPLARY EMBODIMENTS

The air-cargo transport industry continues to find new ways to reduce the consumption of expensive fuel and the excessive production of environmentally harmful CO₂ exhaust emissions. In terms of payload delivery, conventional airplanes are not very fuel-efficient. They also have heavy wing loadings and heavy footprints that make them incapable of accessing short-unhardened airfields. Smaller, lighter cargo airplanes have limited lift capacity and cargo handling capabilities. Other conventional aircrafts (e.g., blimps, hybrid airships) are lightweight, but are also slow and have limited flying-time windows of opportunity because of their susceptibility to windy weather conditions.

Conventional prior-art cargo airplanes are neither designed nor fitted for transporting large ISO intermodal shipping containers. For example, conventional aircrafts cannot ‘top-lift’ an ISO shipping-container off the ground or off the chassis/flatbed of a semi-trailer. Further, no known conventional transport aircraft has a ‘drive-through’ capability for dropping off semi-trailers and other payload packages.

Embodiments include a transport aircraft type devoid of the conventional fuselage, thereby eliminating weight that is reallocated to the payload. Because of this significant shift in the ratio of aircraft empty weight to payload weight, fuel consumption may be dramatically reduced up to 50% per payload ton-mile.

Embodiments include a transport aircraft type that incorporates a convertible, hybrid para-wing (hereinafter para-wing), and an aircraft/payload interface system for accommodating interchangeable intermodal shipping-containers, semi-trailers and general freight. Aspects of the aircraft are configured to work with two basic payload interface systems: (i) a gantry-type top-lift system intended exclusively for ISO intermodal shipping-containers, and (ii) a drive-through payload interface system with drop-off and pick-up capabilities and a cargo deck for types of general freight and miscellaneous payload packages.

Embodiments include a transport aircraft configured to effectively and efficiently transport large payloads by employing a suspension-system type of airframe architecture whereby the payload is hung in suspension directly beneath the aircraft's cockpit nacelle and fixed-wings that are perched upon a set of four long wheels-struts. Embodiments include a transport aircraft without a conventional fuselage, thereby reducing structural weight and significantly increasing the aircraft's fuel efficiency (e.g., in terms of payload per ton-mile delivered).

Embodiments provide an aircraft with a relatively light wing loading and footprint that facilitate short take-off and landing distances and allowing said aircraft to access short-unhardened airfields. Embodiments provide an aircraft costing between ½ to ⅔ less than inefficient heavier cargo aircraft with comparable lift capacity. Embodiments provide an aircraft with reduced fuel consumption of up to 40%-50% less than these heavier inefficient prior-art platforms, as well as significantly reduced maintenance costs due to far fewer moving parts.

Some embodiments provide an aircraft having a gantry-type top-lifting payload interface system configured to lift and secure the ISO intermodal shipping-container for transport. Other embodiments provide an aircraft having a drive-through payload interface system configured as a holding compartment designed to lift the secured payloads held within. The payload is driven into the payload holding compartment that in turn is lifted and secured to the aircraft airframe be means of a plurality of wheel-strut latches.

Some conventional aircrafts include lightweight conventional powered para-foils. These conventional para-foils, however, have difficulty with parafoil deployment, recovery, high level of aerodynamic drag, flying in windy conditions, crosswind takeoffs and landings, directional control in flight, and size limitations and flight above a certain altitude. Embodiments provide a lightweight, structurally convertible, para-wing with compact storability. The flexible skin, convertible hybrid para-wing contains rigid internal structural components. Embodiments include a para-wing with a fully formed leading-edge, while retaining its advantages of light weight, convertibility, and compact storability.

Embodiments provide an aircraft to transport semi-trailers, ISO intermodal shipping-containers, in addition to outsized payload packages. Embodiments provide an aircraft producing significantly lower lifecycle costs to manufacture, operate, maintain, and insure (commercial market).

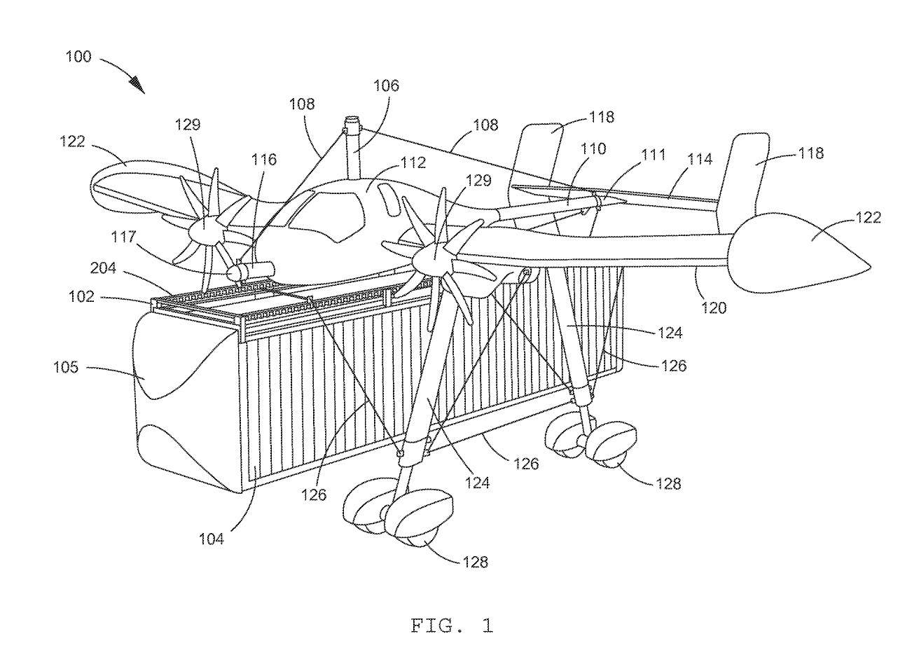

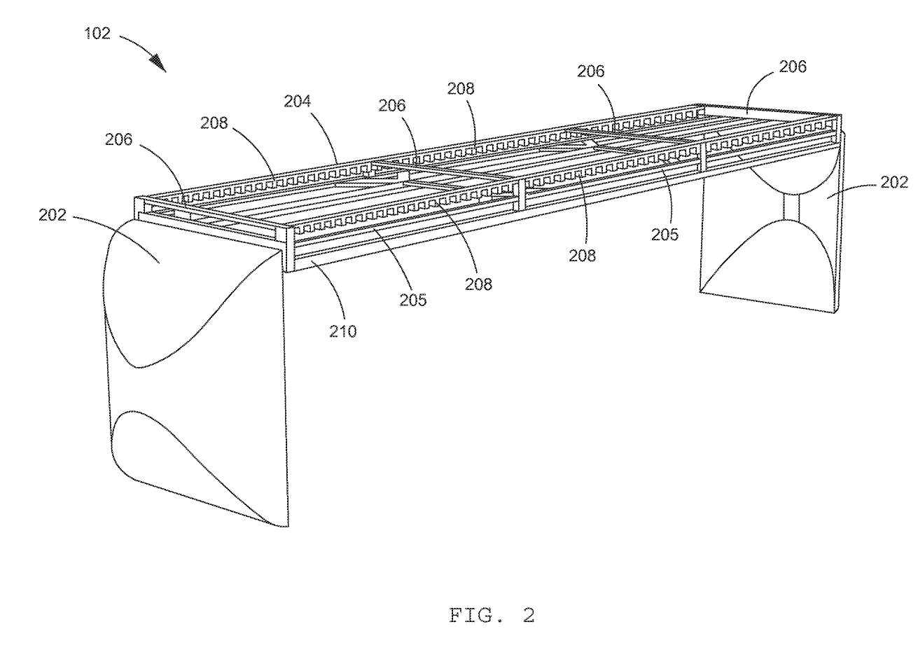

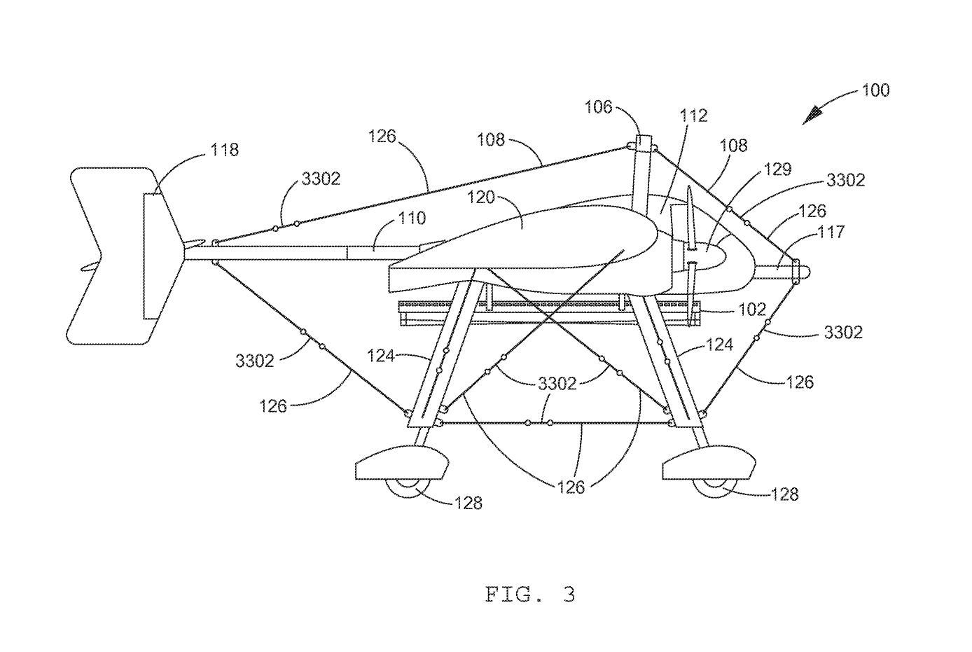

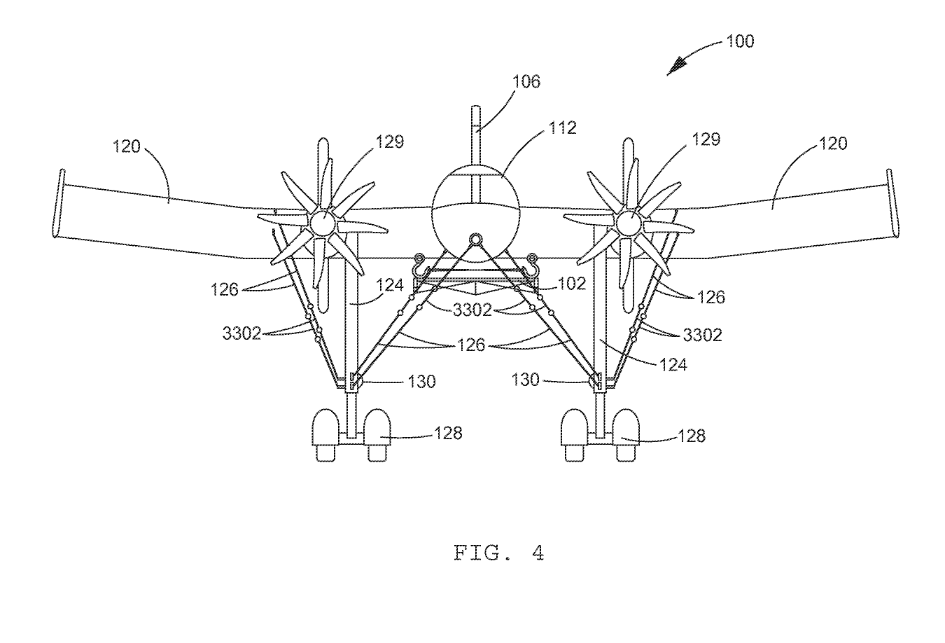

FIG. 1 is a perspective view of a convertible payload transport aircraft 100 according to embodiments disclosed herein. FIG. 2 is a perspective view of top lift payload interface system 102 shown in FIG. 1. FIG. 3A is a wire drawing front view of the convertible payload transport aircraft 100 shown in FIG. 1. FIG. 3B is a wire drawing side view of the convertible payload transport aircraft 100 shown in FIG. 1. As shown in FIG. 1, convertible payload transport aircraft 100 includes a top lift payload interface system 102 for securing payload container 104 to the aircraft 100. Embodiments may include any type of payload (e.g., semi-trailers, ISO intermodal shipping containers, military equipment and the like). Embodiments may also include any size payload (e.g., a 40 ft. ISO container shown in FIG. 1 and FIG. 2, a 20 ft. ISO container shown in FIG. 3A. The aircraft 100 includes a kingpost 106 for holding (e.g., anchoring) the airframe system of cables 108. In some aspects, the frame cables 108 may be adjustable to provide airframe flexion that is predetermined by operational factors, such as ambient air temperature and gross take-off weight.

The aircraft 100 also includes a main body that includes a cockpit nacelle (hereinafter cockpit) 112, a tail boom 110 and a prow mast 116. The tail boom 110 extends from a rear of cockpit 112 to a horizontal stabilizer/elevator 114 and the prow mast 116 extends substantially in the opposite direction from a front of cockpit 112. A first airframe cable 108 extends between kingpost 106 and a distal end 111 of tail boom 110. A second airframe cable 108 extends between kingpost 106 and a distal end 117 of prow mast 116. Vertical stabilizers/rudders 118 for controlling the yaw and forward direction of the aircraft 100 are coupled at opposing ends of horizontal stabilizer/elevator 114. Main wings 120 extend in opposing directions from cockpit 112 and include wingtip plates 122 at distal ends of the main fixed wings 120.

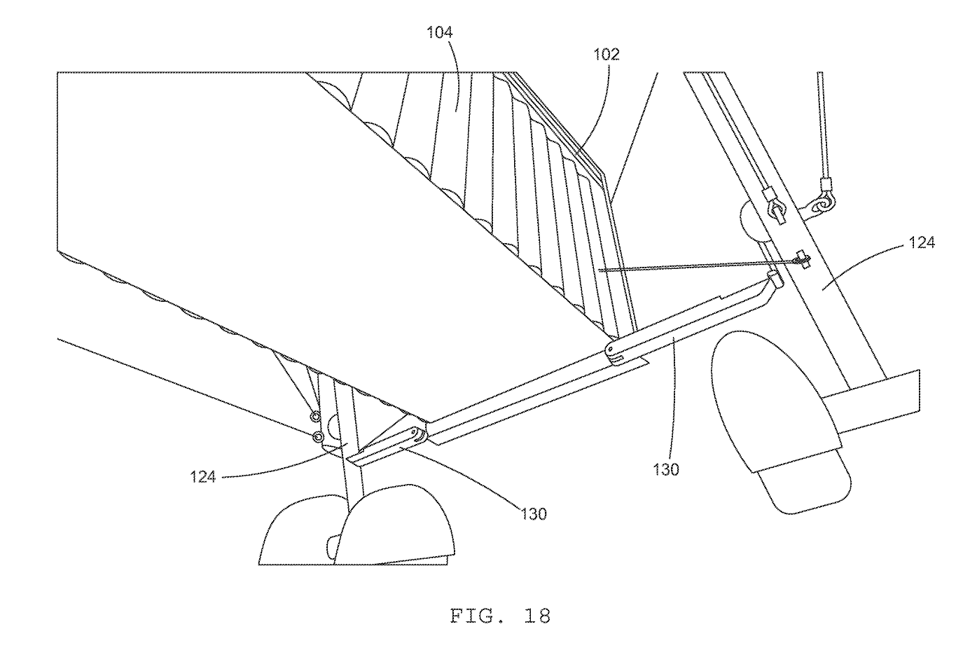

The aircraft 100 also includes a wheel strut system having wheel struts (herein after struts) 124 and wheel strut cables (hereinafter strut cables) 126 that extend between the struts 124 and the main body of the aircraft 100 to strengthen and hold the wheel strut system together. As shown in FIG. 1, strut cables 126 are coupled between the struts 124 and main fixed wings 120. The strut cables 126 are also coupled between the struts 124 and tail boom 110 and between the struts 124 and bow mast 116. Struts 124 include both front and rear struts on each side of aircraft 100 and extend from the main wings 120 on each side to corresponding wheels 128 to provide room for container 104 to be positioned and held underneath the aircraft 100. As shown in FIG. 1, the front and rear struts 124 on each side move away from each other as they extend from the main wings 120 on each side to the corresponding wheels 128. The aircraft 100 also includes propellers 129 having turboprop engines (not shown). In some embodiments, aircrafts may include jet engines. As shown in FIG. 3B, the aircraft 100 may also include pivotable payload latches (hereinafter latches) 130 which may pivot from their respective upright positions shown in FIG. 3B to their respective engaged positions shown in FIG. 16 to limit or prevent movement of the ISO shipping container 104. FIG. 16 is a bottom perspective view of the exemplary top lift payload interface system 102 shown in FIG. 1 and FIG. 2 holding an ISO intermodal shipping container 104 and illustrating the latches 130 extended between the struts 124 and the ISO intermodal shipping container 104.

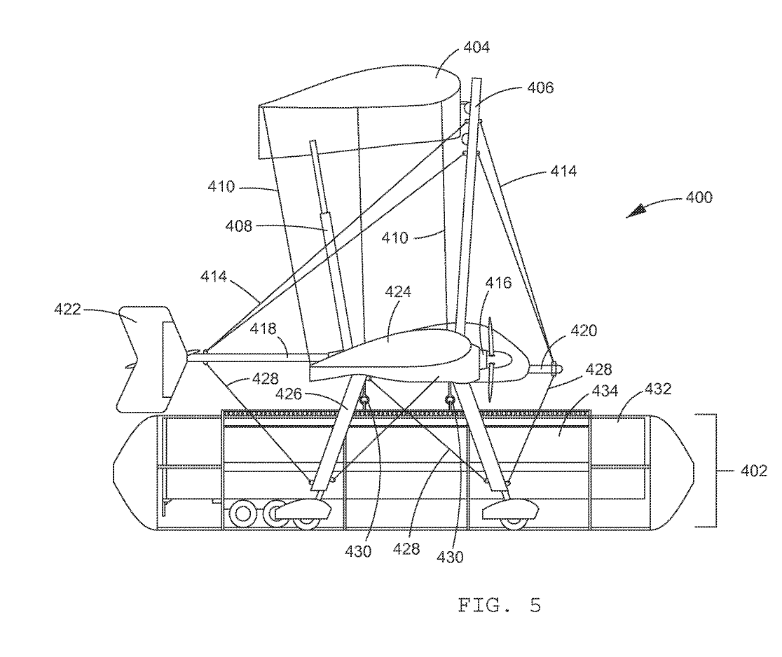

FIG. 2 is a perspective view of top lift payload interface system 102 shown in FIG. 1. As shown in FIG. 2, top lift payload interface system 102 may include a rack 204 and fairings 202 disposed on opposite ends of the rack 204 to aid in flight aerodynamics. Rack 204 may include a plurality of teeth (openings) configured to receive a plurality of engaging elements, such as hooks (e.g., hooks 430 shown in FIG. 4). Accordingly, the container 104 may be adjusted lengthwise along the aircraft 100 to provide a center of gravity adjustment for the container 104. The rack 204 may also include a plurality of side supports 205 and cross-supports 206 for providing rigidity and strength to the rack 204. The top-lift payload interface system 102 may also include container engagement system to secure the container 104 to the rack 204. For example, the container engagement system may include a twist lock key recess 210 configured to receive an engaging portion, such as a twist lock key (not shown) to couple the container 104 to the rack 204.

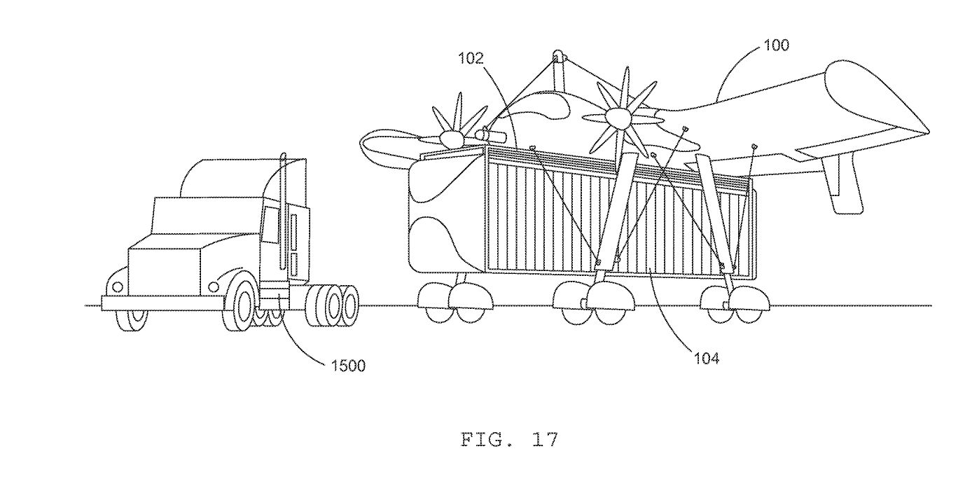

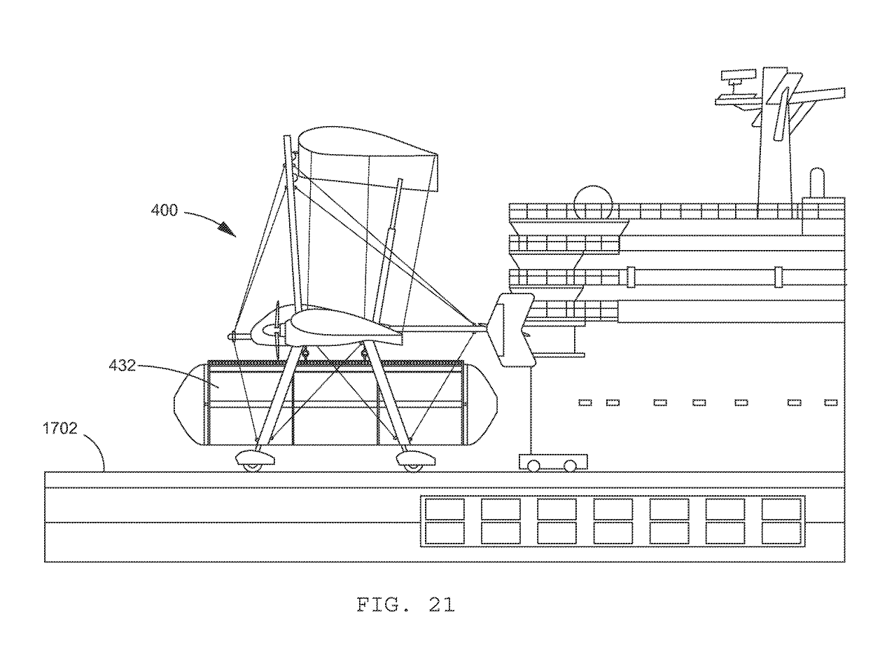

In some embodiments, a vehicle (e.g., truck 1500 shown in FIG. 15) hauling the container 104 may drive under aircraft 100 while it is stationary and place the container 104 in a position under the top lift payload interface system 102 to be picked up by the top lift payload interface system 102. The vehicle may then move away from the aircraft while the container 104 remains with the aircraft. In other embodiments, the aircraft 100 may drive over a stationary container 104 until the container 104 is in the position under the top lift payload interface system 102 to be picked up by the top lift payload interface system 102. Container may be picked up (e.g., by hooks 430 shown in FIG. 4) and secured at a position for transport, (e.g., position shown at FIG. 19). The center of gravity may be adjusted by: (i) determining the center of gravity of the container prior to securing the container 104 to the aircraft 100 then securing the container 104 to the rack 204 at a position based on the determined center of gravity of the container 104; or (ii) securing the container 104 to the aircraft 100 and determining the center of gravity based on trial and error of adjusting the container along the length of the aircraft 100.

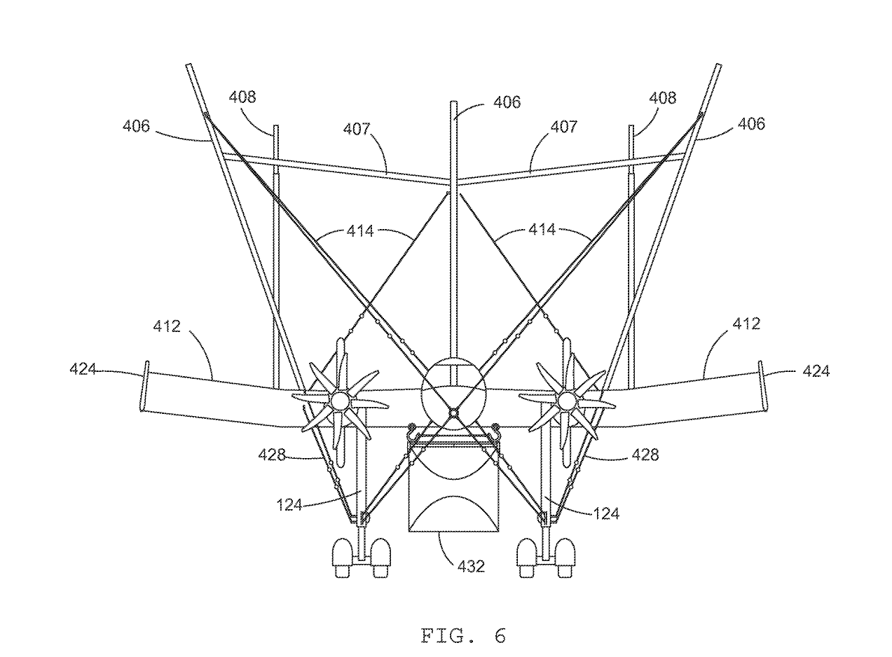

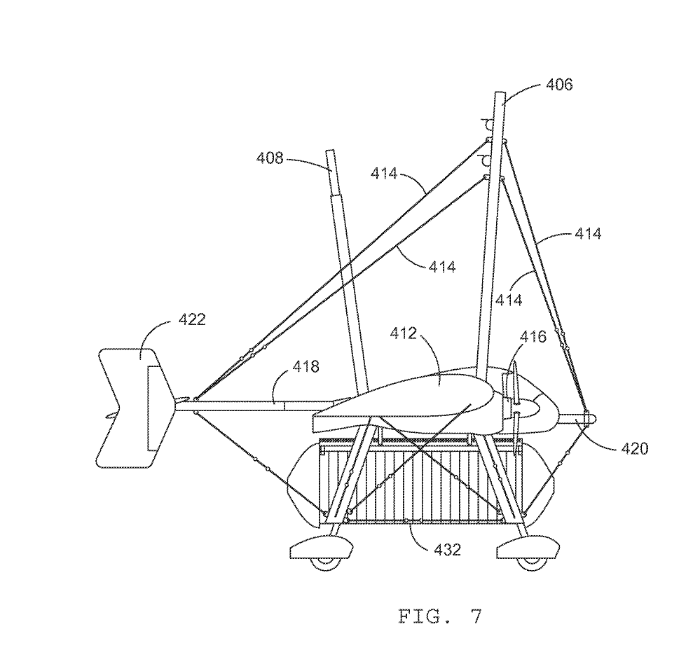

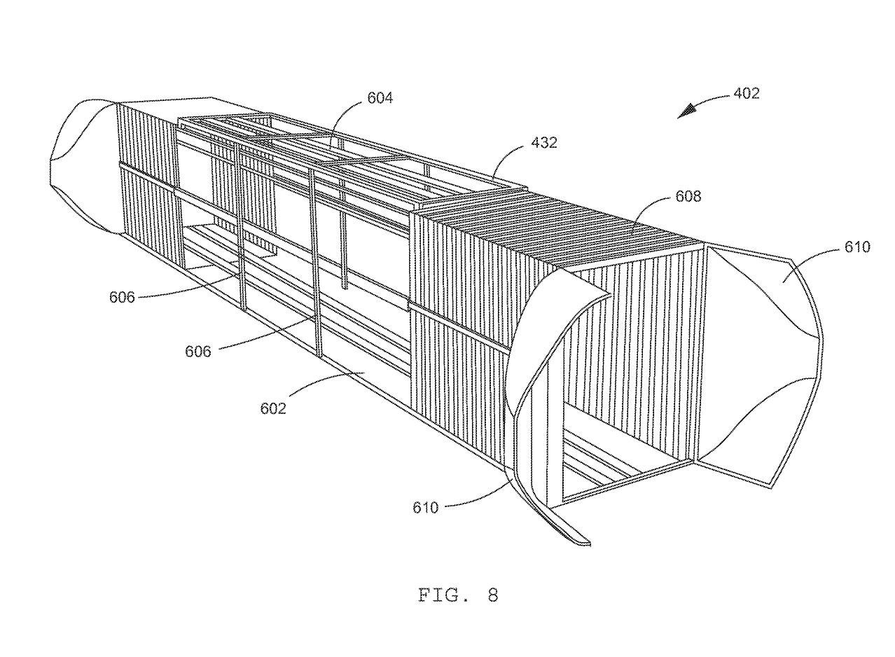

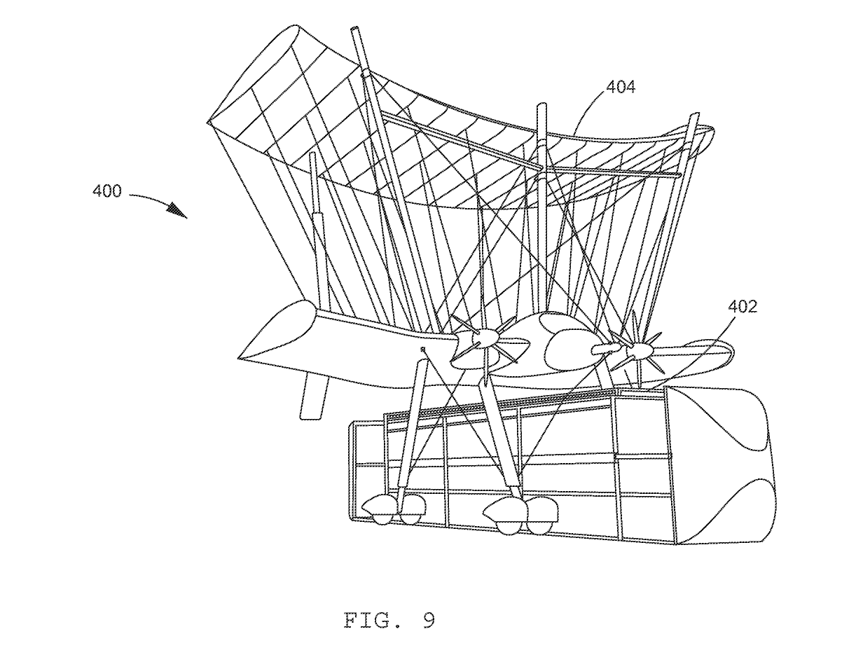

FIG. 4 is a side view of a convertible payload transport para-wing transport aircraft 400 having a deployed removable para-wing 404 and illustrating a drive-through payload interface system 402 according to embodiments disclosed herein. FIG. 5A is a wire drawing front view of the convertible payload transport para-wing aircraft 400 shown in FIG. 4 without the removable para-wing 404. FIG. 5B is a wire drawing side view of the convertible payload transport para-wing aircraft 400 shown in FIG. 4 without the removable para-wing 404. Para-wing 404 may be deployed to transport general payloads and intermodal shipping containers whose weights exceed the aircraft's fixed-wing operational weight limitations. FIG. 6 is a perspective cut-away view of the payload holding compartment 432 shown in FIG. 4. FIG. 7 is a front perspective view of the convertible payload transport para-wing aircraft 400 shown in FIG. 4.

Embodiments include an aircraft 400 having a para-wing 404 and a para-wing mast system configured to be coupled to and secure para-wing 404. For example, as shown in FIG. 5A, para-wing mast system may include three forward fixed para-wing masts 406 supported by spacers 407 and two rear moveable para-wing masts 408. The rear moveable para-wing masts 408 may be configured to move in a telescoping-like fashion. Although the aircraft 400 shown in the embodiment at FIG. 5A includes three front fixed para-wing masts 406 and two rear moveable para-wing masts 408, embodiments may include any number of front fixed para-wing masts and rear moveable para-wing masts.

As shown in FIG. 4, aircraft 400 includes riser lines 410 that couple the para-wing 404 to the main wings 412 that extend in opposing directions from the cockpit 416. Aircraft 400 also includes a mast system having mast cables 414, front fixed para-wing masts 406, rear moveable para-wing masts 408, the tail boom 418 and the bow mast 420. Mast cables 414 are coupled between front fixed para-wing masts 406 and rear moveable para-wing masts 408, the tail boom 418 and bow mast 420 for securing the para-wing 404 before and during flight. Aircraft 400 also includes rudders and vertical stabilizers 422 disposed at a distal end of tail boom 418 and fixed wing plates 424 disposed at distal ends of main wings 412, struts 426, strut cables 428 and hooks 430 for coupling a payload holding compartment 432 of payload interface system 402 to the aircraft 400.

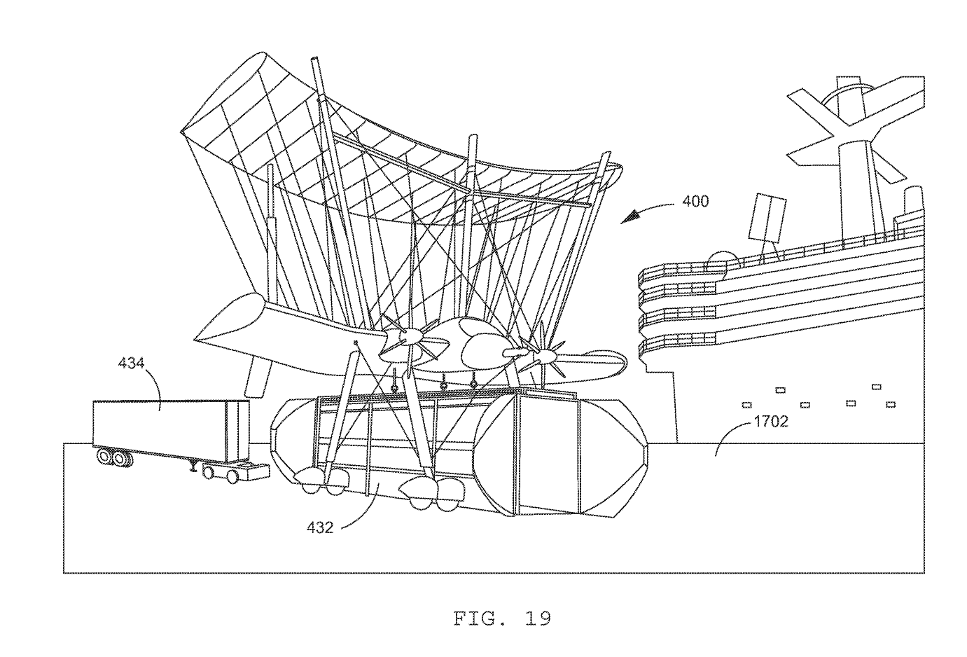

FIG. 4 shows a cut-away view of payload holding compartment 432 to illustrate a payload 434 within the payload holding compartment 432. Payload holding compartment 432 may include side walls, as shown for example on payload holding compartment 432 shown in FIGS. 17-20. The payload 434 shown in the embodiment at FIG. 4 is a semi-trailer. Embodiment may, however, include other types of payloads, such as ISO intermodal shipping containers, military equipment and other payloads that may be moved and held within the payload holding compartment 432.

FIG. 6 is a perspective cut-away view of the payload holding compartment 432 shown in FIG. 4. As shown in FIG. 6, the payload holding compartment 432 may include a cargo deck 602, a top rack 604, columns 606, expandable bellows 608 and a pair of moveable aerodynamically shaped fairing doors 610 configured to open and close. Top rack 604 may also include a plurality of openings (such as the openings 208 shown in FIG. 2) configured to receive a plurality of engaging elements, such as hooks 430 (shown in FIG. 4) which emanate from beneath the main fixed wings 412.

The payload holding compartment 432 may be configured to be lifted (e.g., by hooks 430 in FIG. 4) from the top of payload holding compartment 432 similar to lifting of the top-lift payload interface system 102 shown in FIG. 1. The payload holding compartment 432 of drive-through payload interface system 402, however, has a cargo deck 602 that is coupled to the top rack 604 by columns (or rods) 606 or cables. Therefore, when payload holding compartment 432 is lifted, the load (from the payload) may be distributed (e.g., uniformly) from the cargo deck 602 to the top rack 604 via load paths of the columns 606.

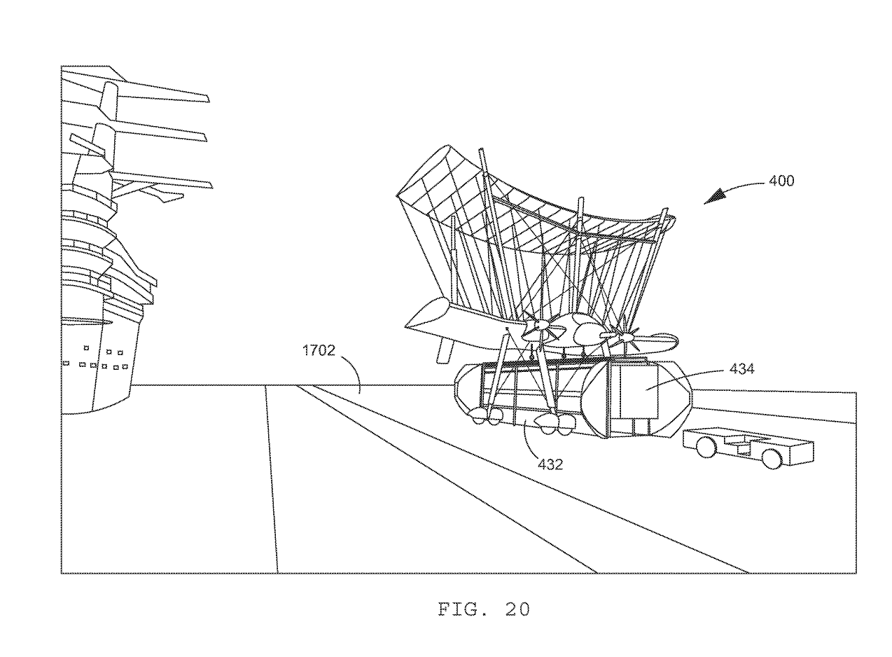

An exemplary method of loading a payload (e.g., payload 434) onto the aircraft 400 for transport is now described with reference to FIG. 17-FIG. 19. The payload holding compartment 432 that is coupled to the aircraft 400 may be placed at a location (e.g., on a surface, such as an airfield, a hanger or deck 1702 of ship as shown in FIG. 17). Extendable bellows 608 (shown in FIG. 6) may be adjusted before enclosing the payload 434 depending on the size of the payload. The semi-trailer payload 434 may then be moved within the payload holding compartment 432 as shown in FIG. 18. In other embodiments, however, the payload 434 may first be moved within the drive-through-payload interface system 432 prior to the aircraft 400 being connected to the drive-through-payload interface system 432 shown in FIG. 17.

When the payload holding compartment 432 and the aircraft 400 are in the position shown in FIG. 17, moveable fairing doors 610 may be closed and payload holding compartment 432 may be picked up (e.g., by hooks 430) and secured at a position for transport shown in FIG. 19. The payload holding compartment 432 may include components similar to those shown and described in FIG. 2. For example, rack 604 may include features similar to rack 204 shown in FIG. 2, such as a plurality of teeth (openings) configured to receive a plurality of engaging elements, such hooks 430. Accordingly, the payload holding compartment 432 may be adjusted lengthwise along the aircraft 400 to provide a center of gravity adjustment for the payload holding compartment 432. Rack 604 may also include the plurality of side supports 205 and cross-supports 206 shown in FIG. 2. The payload holding compartment 432 may also include an engagement system that may include similar features to the engagement system shown in FIG. 2, such as key lock recess 210 configured to receive an engaging portion to couple the payload holding compartment 432 to the rack 604.

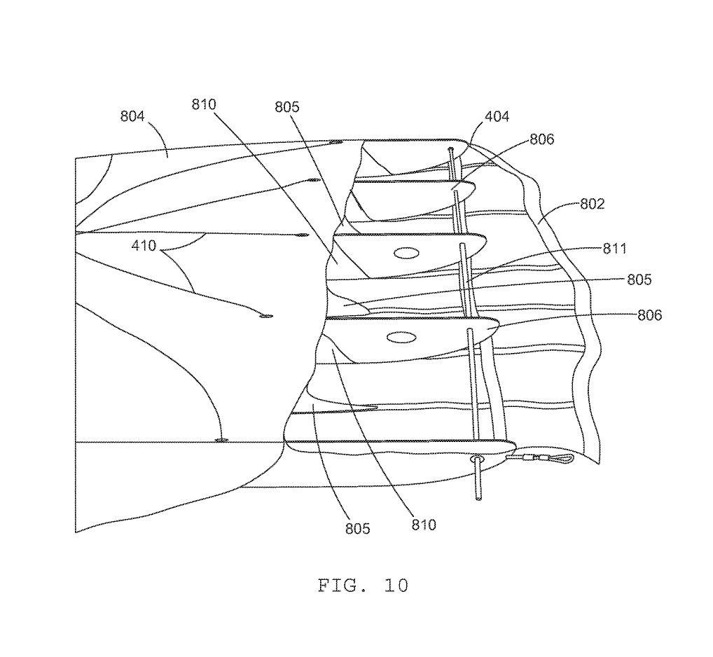

Determination of deployment of the para-wing 404 is based upon payloads to be lifted and transported. For example, if a payload exceeds a pre-determined weight, then para-wing may be deployed. The para-wing 404 may be deployed onto aircraft 400 by hoisting the para-wing 404 from the surface (e.g., by a ground crew) prior to the aircraft 400 taking off. In some embodiments, para-wing 404 may be hoisted into position on the aircraft 400 via hooks (not shown) that are coupled to the mast system. The hooks may be on a halyard line and the para-wing may be hoisted up using the halyard lines and secured in position. The para-wing 404 may include trail edge movable masts 408 that may be locked into position on the underside of the trailing edge of the para-wing 404 to help secure the para-wing 404 to the aircraft 400. FIG. 8 is a perspective view of a partially unzipped para-wing 404 that may be used with embodiments disclosed herein. As shown in FIG. 8, the leading edge 802 of the para-wing 404 has been pulled back, exposing its internal components. Para-wing 404 includes flexible fabric 804 (e.g., nylon) and rigid components, such as ribs 806 and spar-rod rib spacers 811.

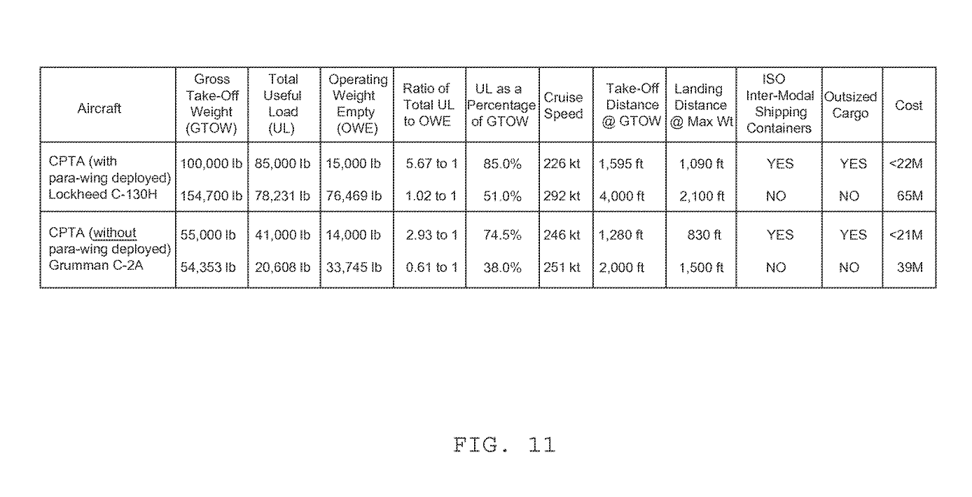

As shown in FIG. 8, flexible fabric 804 may include upper and lower flexible surfaces, flexible ribs 805 extending between the upper and lower flexible surfaces and rib pockets 810. Further, para-wing 404 may include multiple rigid ribs 806 at least partially housed in the rib pockets 810 facilitating airflow over and under the airfoil. In some embodiments, rigid ribs 806 may be solid. In other embodiments, rigid ribs 806 may be hollow. The para-wing 404 may also include riser lines 410 for transferring the load path from the upper wing to the payload below. In some embodiments, rigid ribs 806 may be attached to the riser lines 410 to facilitate distribution of the load equally along the cord length of the ribs, and with no riser line connections to the parafoil fabric itself. The para-wing 404 may also include spar-rod rib spacers 811 to space the ribs 806 apart and provide shape to the para-wing 404. As shown in the embodiment at FIG. 8, the ribs may be spaced equally apart from each other. In other embodiments, however, ribs may be not be spaced equally apart from each other. Exemplary para-wings may include any number of spacer rods. For example, exemplary para-wings may include leading edge spar-rod rib spacers, a trailing edge spar-rod rib spacers and a middle section spar-rod rib spacers. Rigid ribs 806 may be made from any material configured to provide light-weight and strength, such as wood, fiberglass, alloy metals and composites. Flexible fabric 804 may be made from any lightweight, non-porous material configured to provide air resistance and strength, such as rip-stop nylon. In some embodiments, para-wing 404 may include ports configured to facilitate ram air inflation and pressurization. For example, the ports may be elongated buttonhole slits positioned horizontally along the tip of the leading edge 802 to facilitate the ram air inflation and pressurization. In some embodiments, the spar-rod rib spacers 811 may include distal end flange connectors (e.g., t-nuts and cotter pins) that internally engage the two opposite end outer most ribs of the rigid ribs 806 in order to fix and set the hybrid parafoil's span-wise dimension, thus preventing the inflated pressurized cells from ballooning up and deforming, and negatively affecting proper airflow. FIG. 9 includes a comparison of conventional aircrafts to embodiments of aircrafts (e.g., aircraft 100, aircraft 400) described herein with the para-wing 404 deployed and without the para-wing 404 deployed.

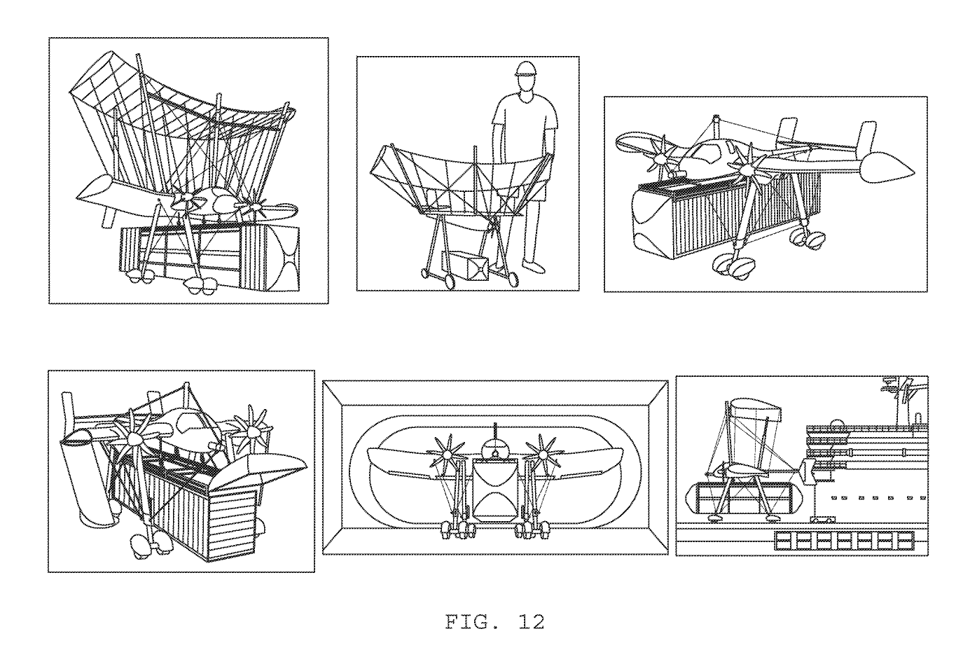

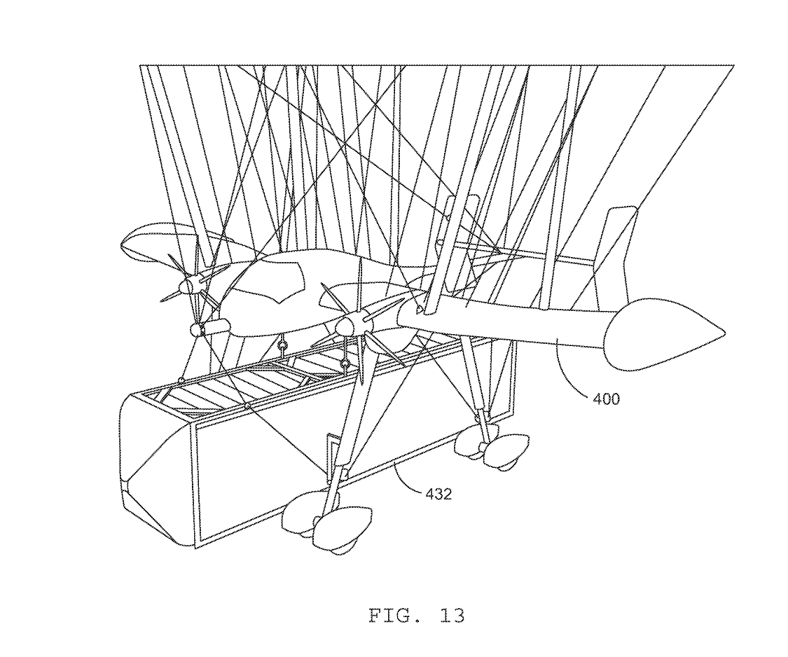

FIG. 10 shows various images of aircrafts according to embodiments described herein. The image at the bottom left shows an aircraft standing by with its fixed-wings folded down, the container lowered to the ground, the strut/payload latch mechanism in the upright position, and the top-lift payload interface system's fairings lifted up. With the fixed-wings folded down the airplane has a relatively small footprint, occupying a nominal amount of deck space area. The image at the bottom center shows an airplane entering an aircraft carrier hanger deck through a hanger opening and illustrates the size-compatibility of the airplane with aircraft carrier basing. The image at the bottom right shows an airplane loaded and prepared for takeoff from an aircraft carrier, illustrating its suitability for at sea basing on a ship that may be utilized for naval applications. FIG. 11 is a perspective view of the aircraft 400 holding a top-lifted ISO intermodal shipping-container 432 and showing the riser lines and the cable lines attaching upwards to the para-wing masts and hybrid para-wing structure.

FIG. 11 is a perspective view of the aircraft 400 in flight holding a payload holding compartment 432 and showing the riser lines and the cable lines going to the upper structure.

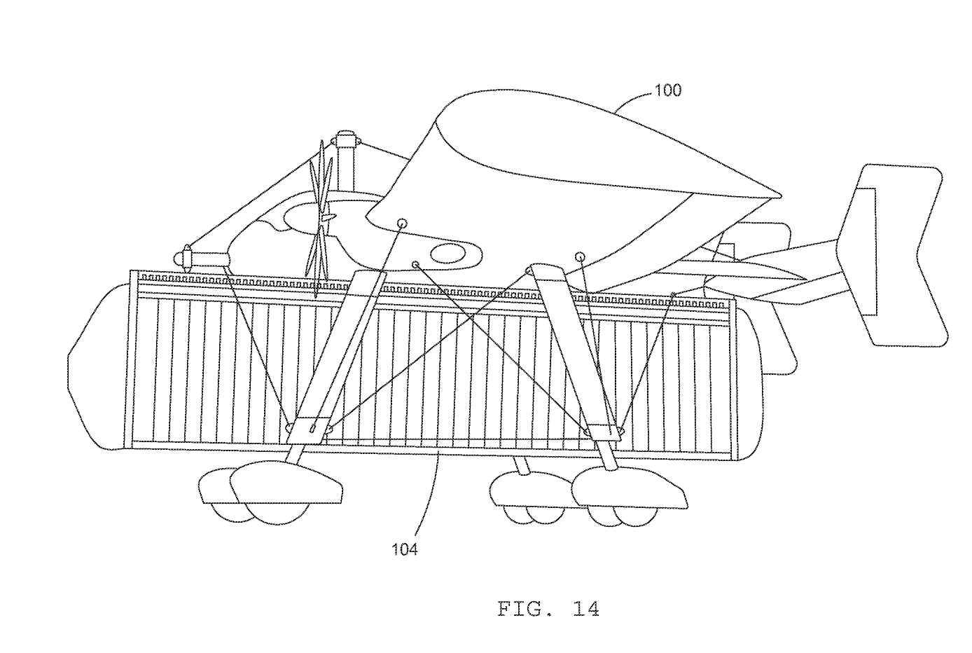

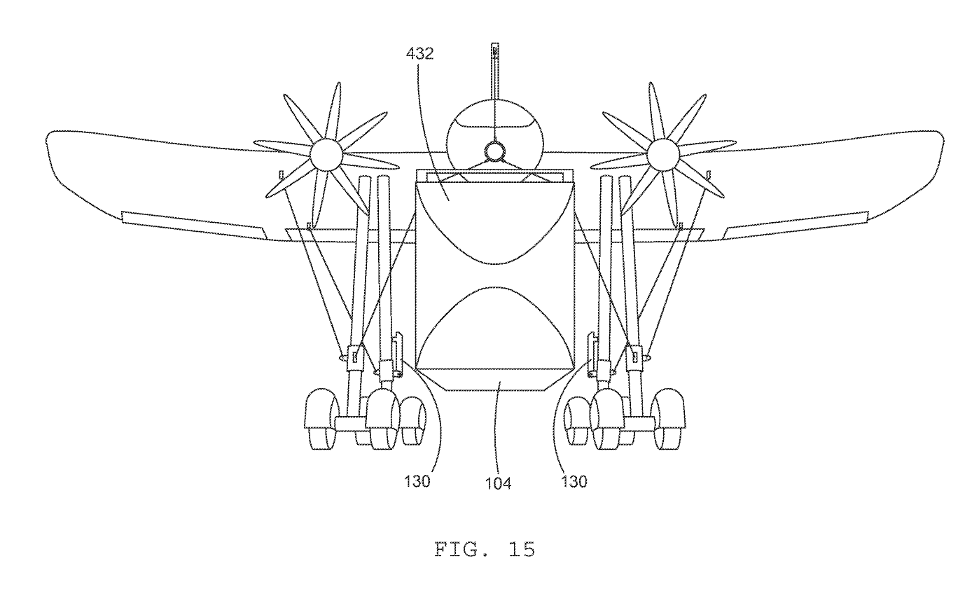

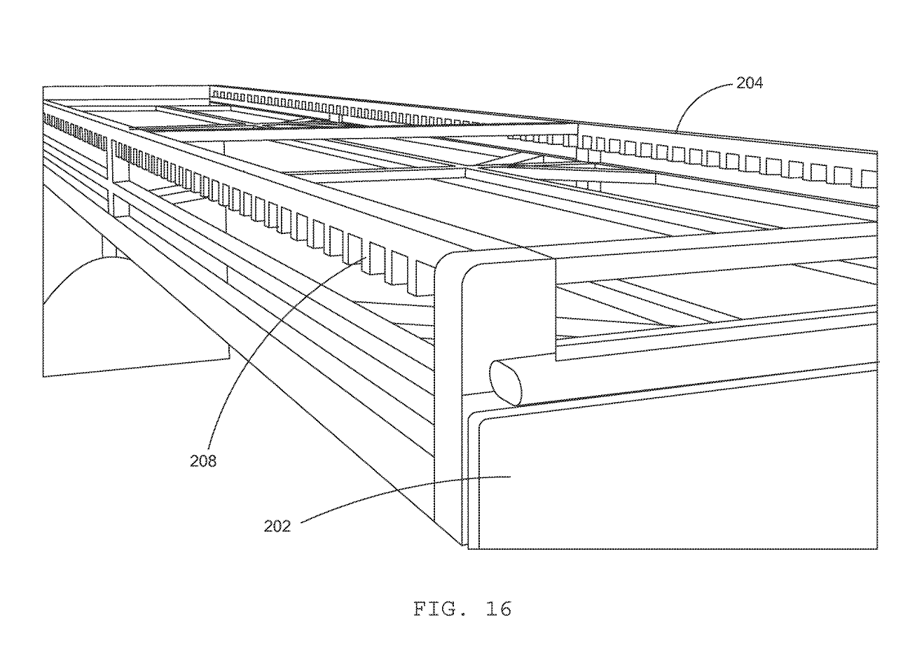

FIG. 12 is a side view of the aircraft 100 holding a 40 ft. ISO intermodal shipping container. FIG. 13 is a front view of aircraft 100 showing the container 104 lifted up from the ground and strut latches 130 unlocked and in an upright position. FIG. 14 is a close-up perspective view of the top lift payload interface system 102 shown in FIG. 1 and FIG. 2. FIG. 15 is a perspective view of a truck 1500 pulling away from an aircraft 100 that has secured a container 104 in a position for transport according to some embodiments described herein. FIG. 16 is a perspective view of the top lift payload interface system 102 shown in FIG. 1 and FIG. 2 holding an ISO intermodal shipping container 104 and illustrating exemplary latches 130 extending between wheel struts 124 and the ISO intermodal shipping container 104 according to embodiments disclosed herein.

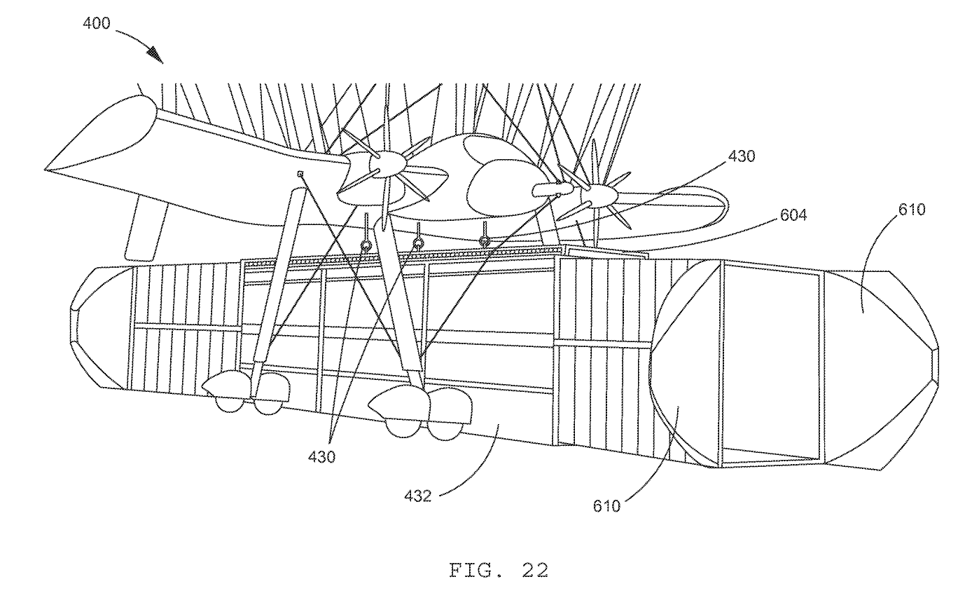

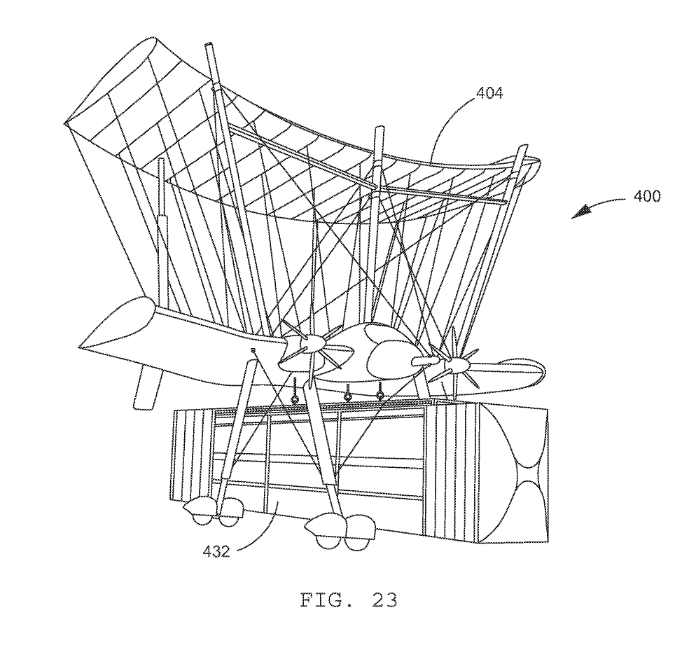

FIG. 20 is a perspective view of aircraft 400 with hooks 430 coupled to the rack 604 of the payload holding compartment 432 resting on the ground with the fairings 610 in an open position ready to receive a payload. FIG. 21 is a perspective view of aircraft 400 with the para-wing 404 deployed and securing a payload held within the payload holding compartment 432.

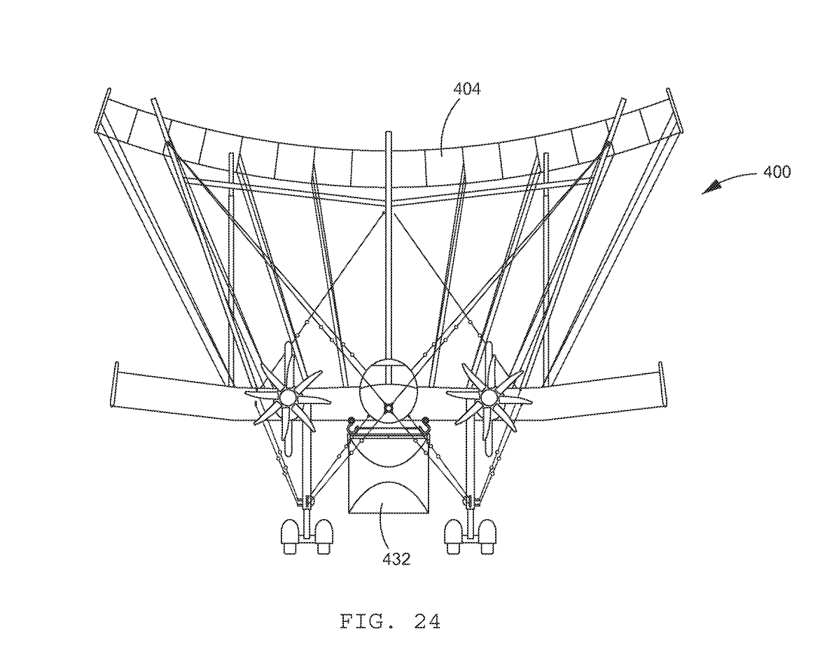

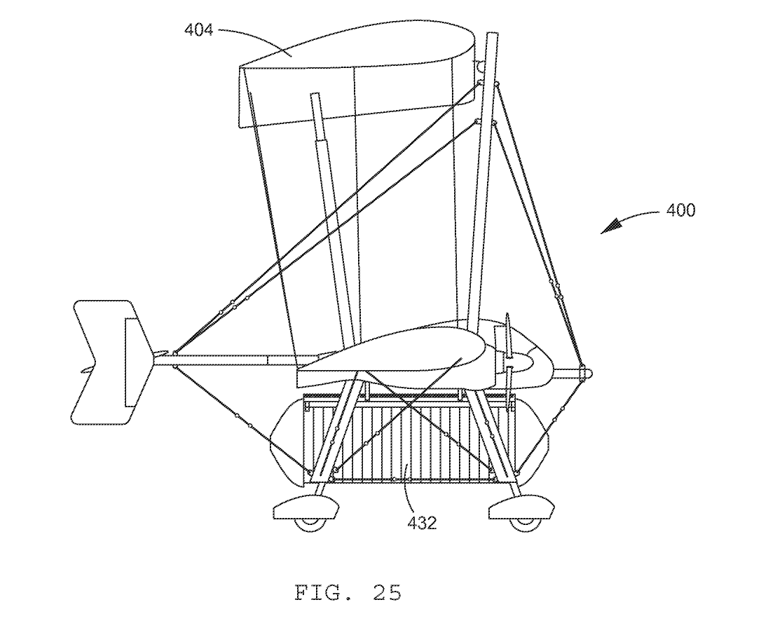

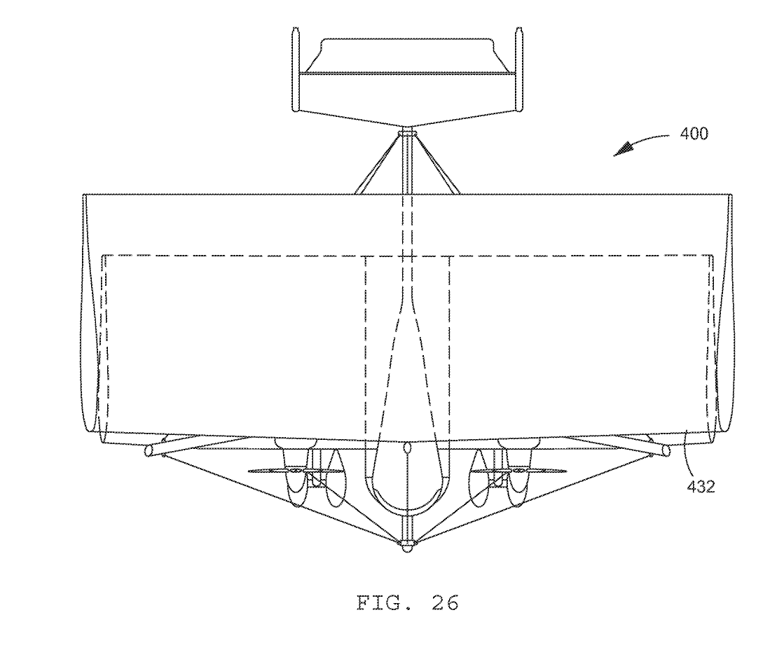

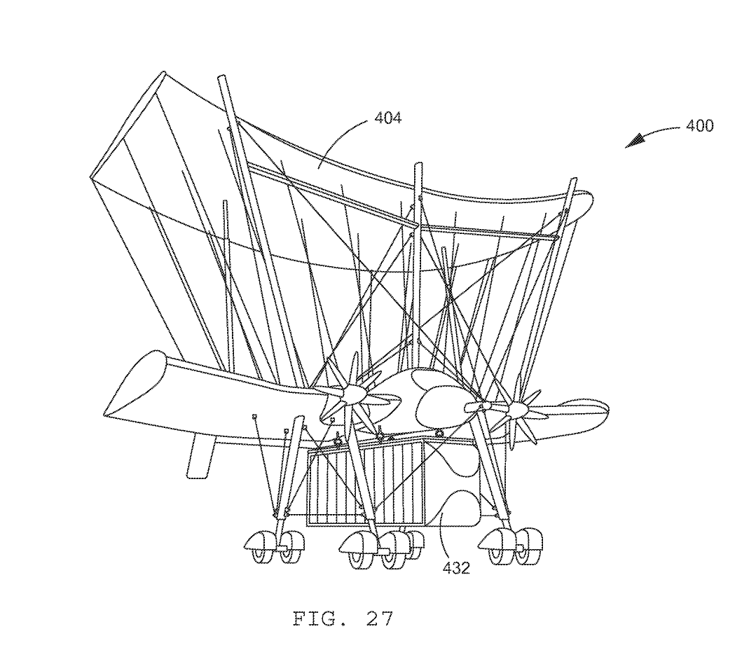

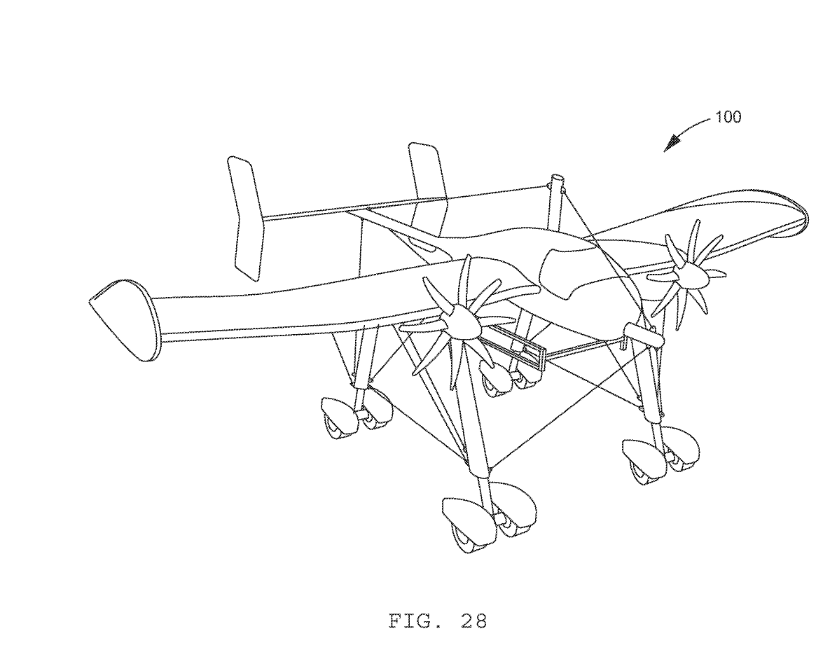

FIG. 22 is the same wire drawing of aircraft 400 shown in FIG. 5A with the para-wing 404 deployed. FIG. 23 is the same wire drawing of aircraft 400 shown in FIG. 5B with the para-wing 404 deployed. FIG. 24 is a line drawing illustrating a top view of the aircraft 400 shown in FIG. 5A and FIG. 5B with the para-wing 404 deployed. FIG. 25 is a wire drawing perspective front view of aircraft 400 with the para-wing 404 deployed and securing payload holding compartment 432. FIG. 26 is a wire drawing perspective view of aircraft 100 without ISO shipping-container payload.

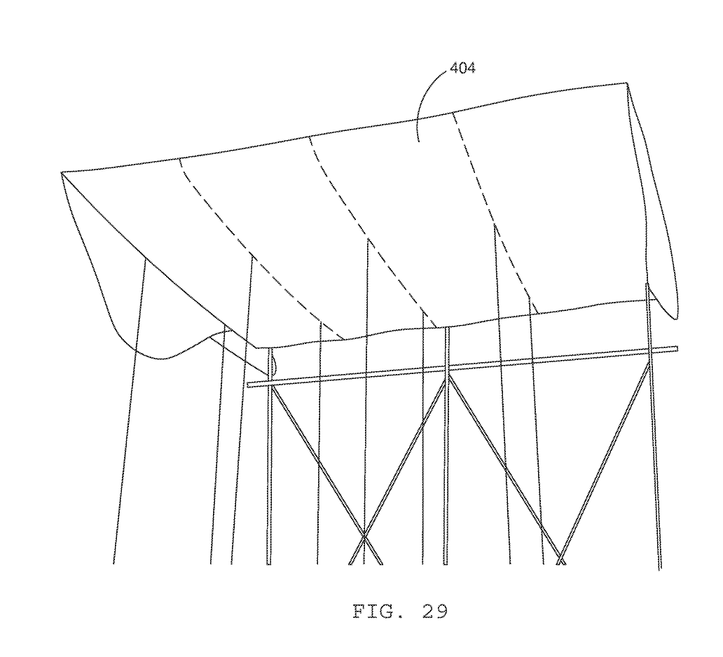

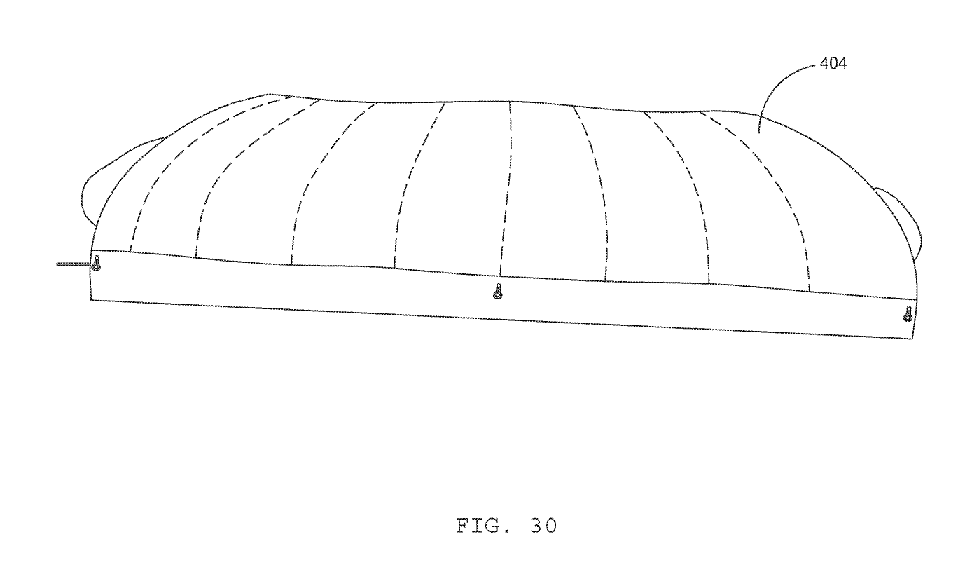

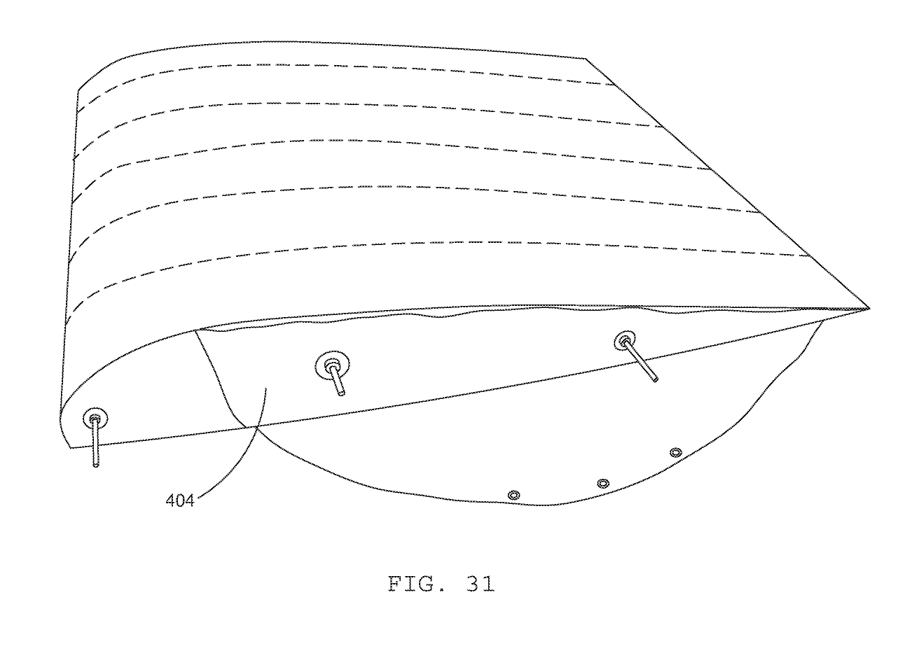

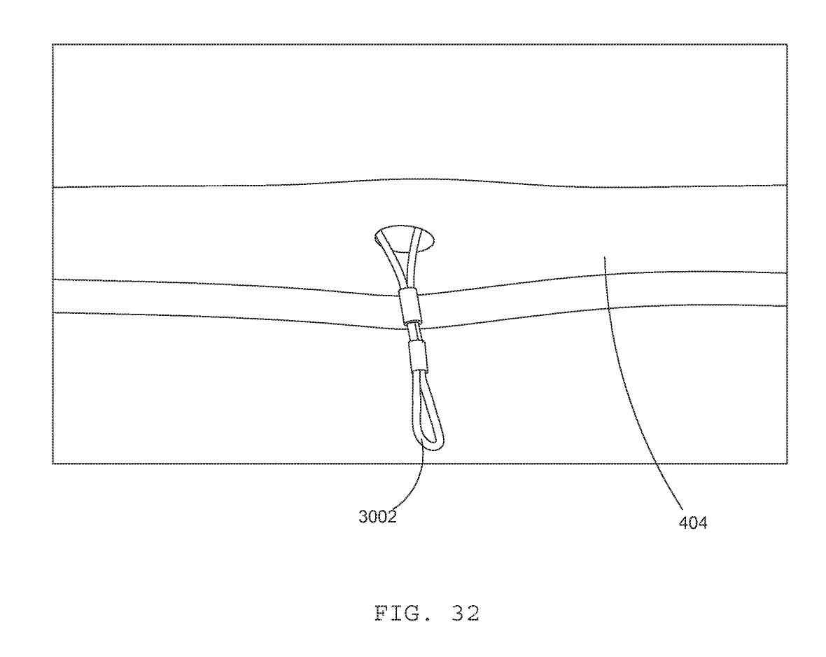

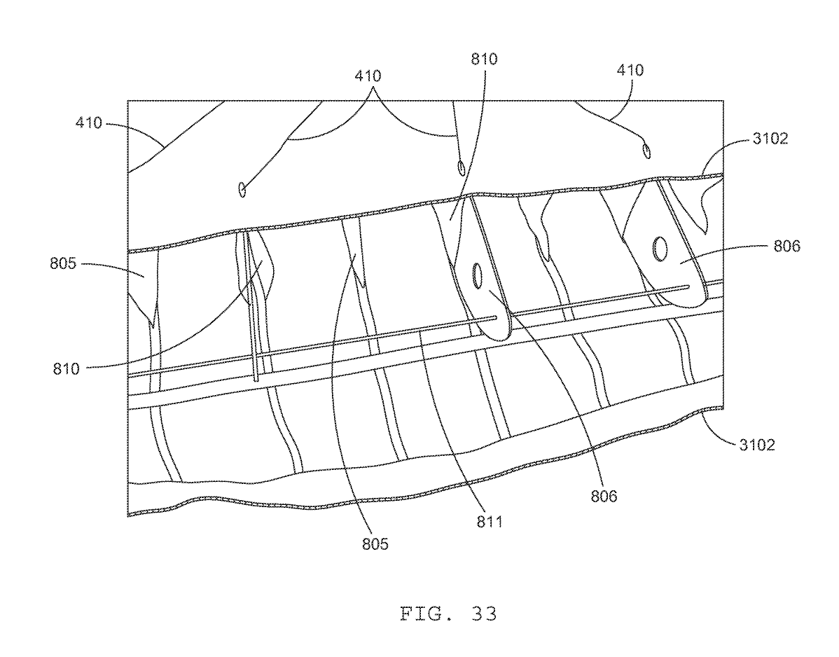

FIG. 27 is a perspective view of para-wing 404 showing the trailing edge and bottom of para-wing 404 in an open position. FIG. 28 is a perspective view of para-wing 404 pre-shaped without dynamic input or ram-air inflation. FIG. 29 is a perspective side view of para-wing 404 with an outer portion of fabric 804 removed and showing a cross-section of an outer rib 806. FIG. 30 is a close-up view of a portion of para-wing 404 showing cables 3002 configured to couple between the ribs 806 of the para-wing 404 and the mast system of aircraft 400. FIG. 31 is a close-up view of a portion of para-wing 404 including zipper 3102 having opposing zipper teeth. Zipper 3102 may span the length of the fabric (or a portion of the length). As shown in FIG. 31, a portion of fabric 804 is unzipped showing the internal components of the para-wing 404, including spar rod rib spacers 811, ribs 806 and rib pockets 810. Although the embodiments shown in FIG. 31 illustrates a zipper 3102 as a device configured to open and close the fabric 804, embodiments may include a para-wing in which the fabric is opened and closed using other types of open/closure mechanisms, such as for example, buttons, snaps, Velcro and the like.

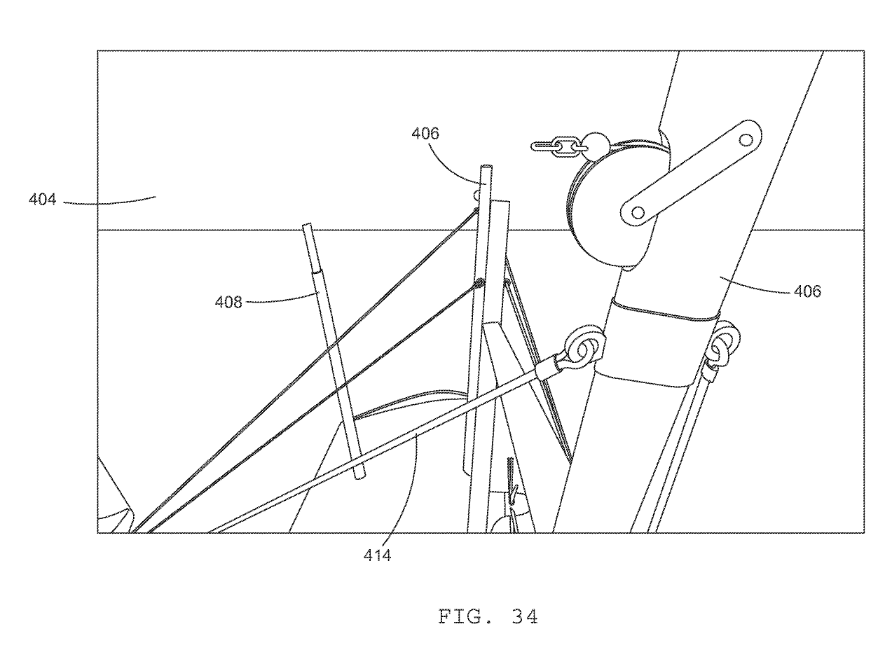

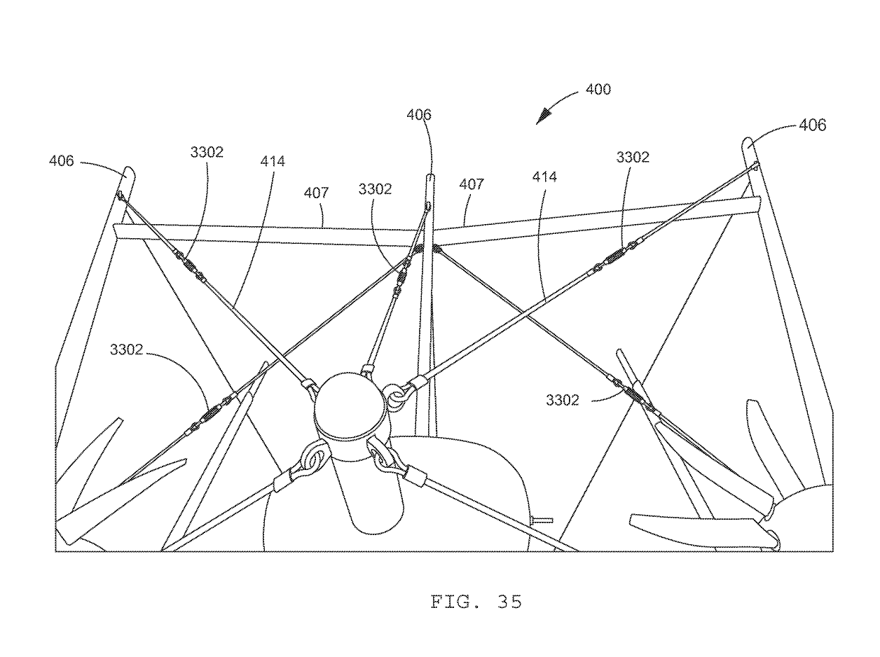

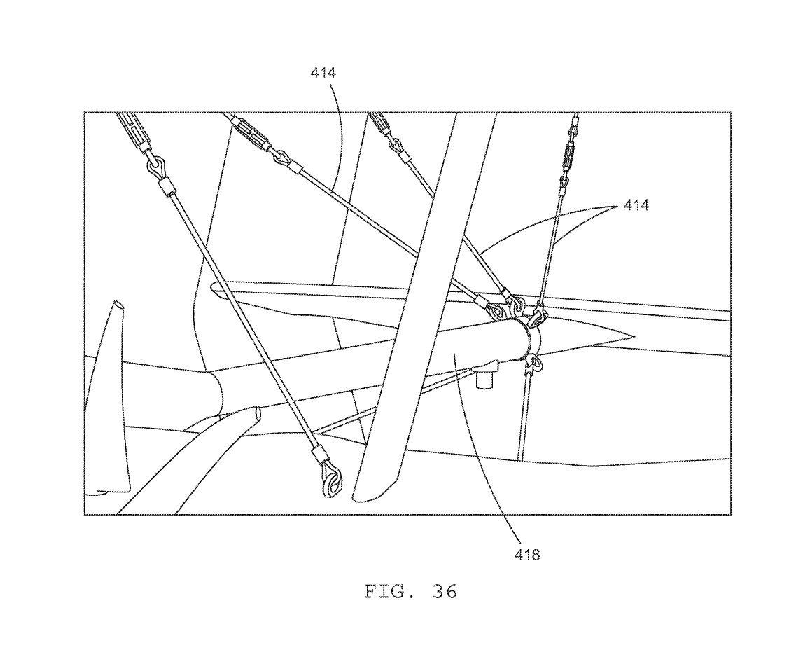

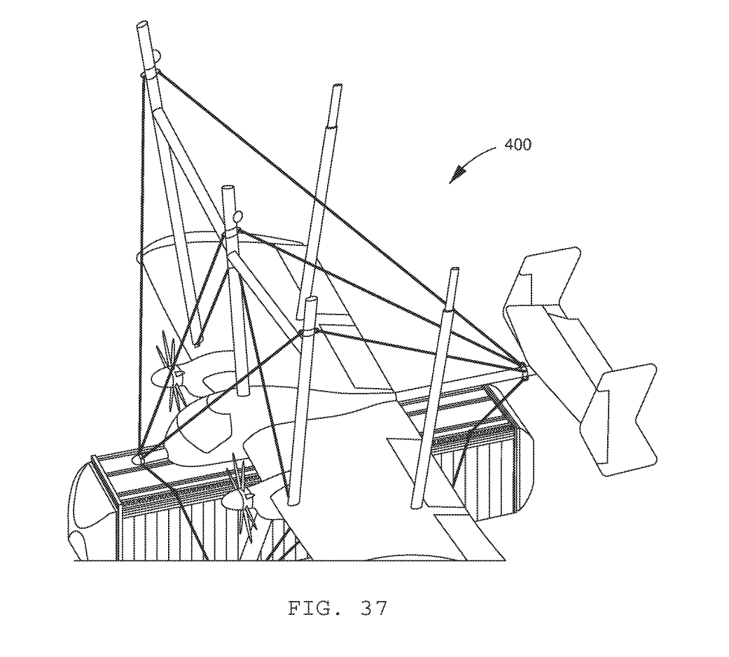

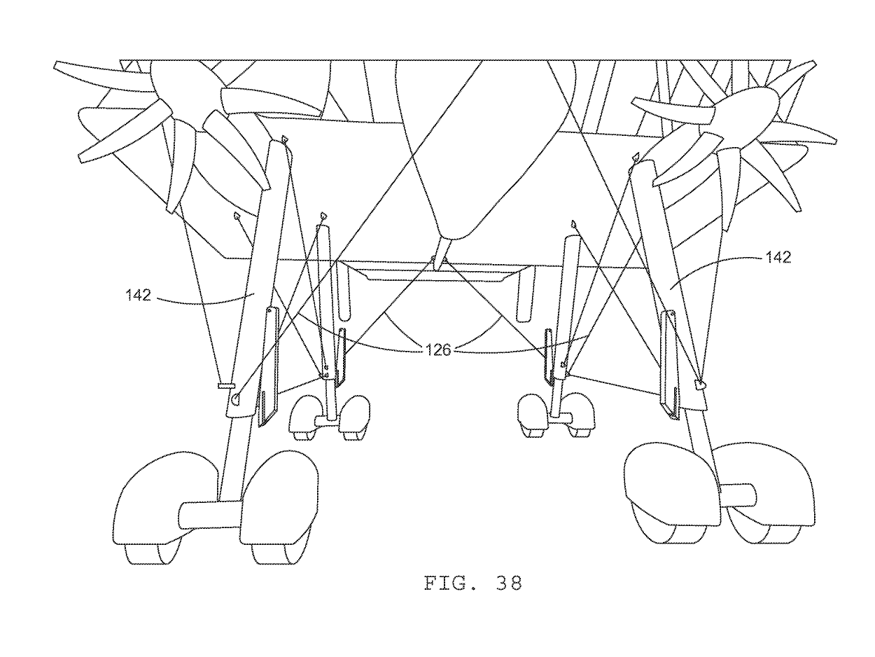

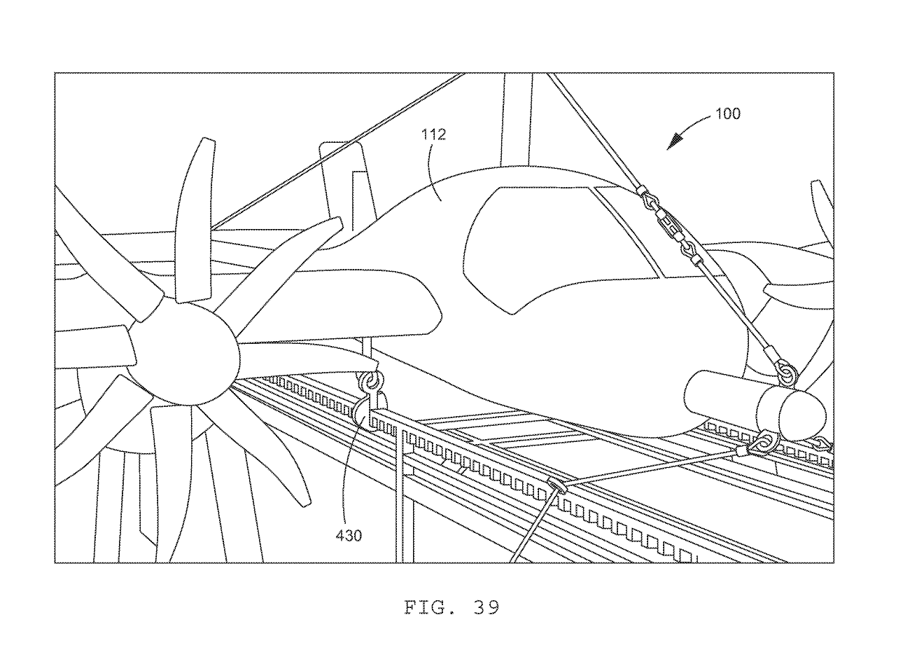

FIG. 32 is a close-up view of a portion of the mast system shown in FIG. 4, FIG. 5A and FIG. 5B, showing the leading edge of the para-wing 404 coupled to forward fixed para-wing masts 406 and rear moveable para-wing masts 408. FIG. 33 is a close-up perspective view of the mast system illustrating forward fixed para-wing masts 406, cables 414 and tension adjusting turnbuckles 3302 and airframe flexion spring coils. FIG. 34 is a close-up perspective view of the mast system illustrating cables 414 locking into the distal end of the tail boom 418. FIG. 35 is a top perspective view of aircraft 400 showing the mast system without para-wing 404 deployed. FIG. 36 is a bottom perspective view of aircraft 100 illustrating struts 142 and cables 126. FIG. 37 is a close-up perspective view showing the cockpit 112 and the payload interface system 102 with hooks 430 (shown in FIG. 4).

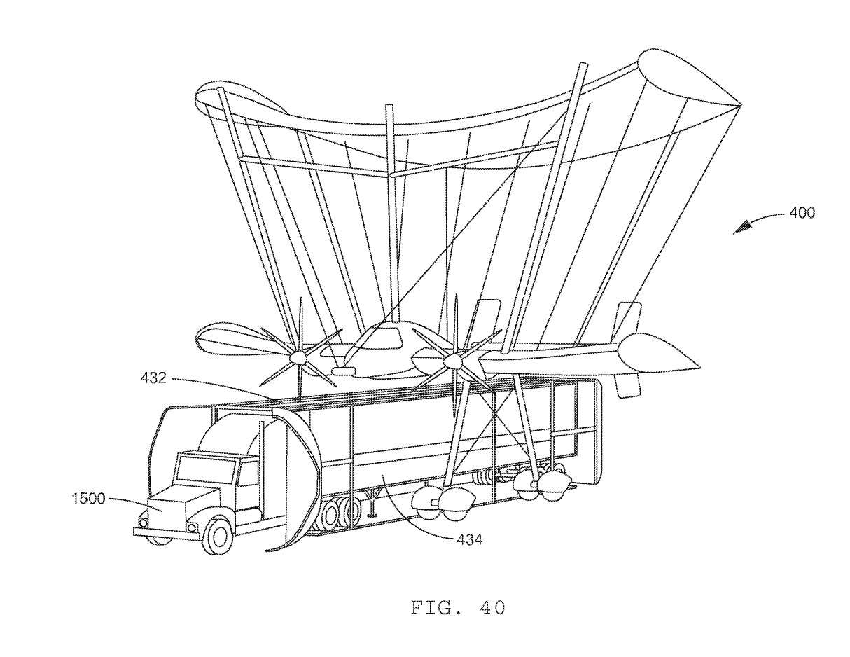

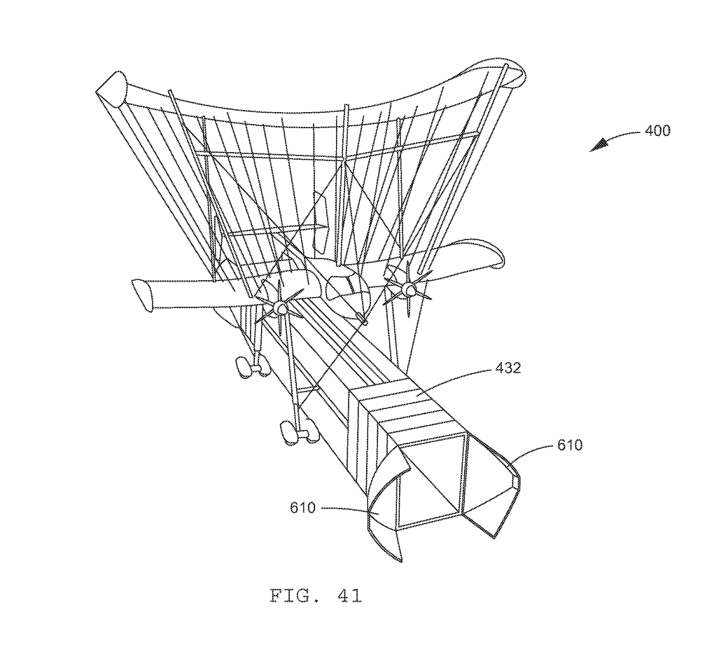

FIG. 38 is a front perspective view of aircraft 400 holding payload holding compartment 432 with truck 1500 hauling payload 434 within payload holding compartment 432. FIG. 39 is a perspective view of aircraft 400 with payload holding compartment 432 at a position on the ground with fairings 610 open to receive a payload.

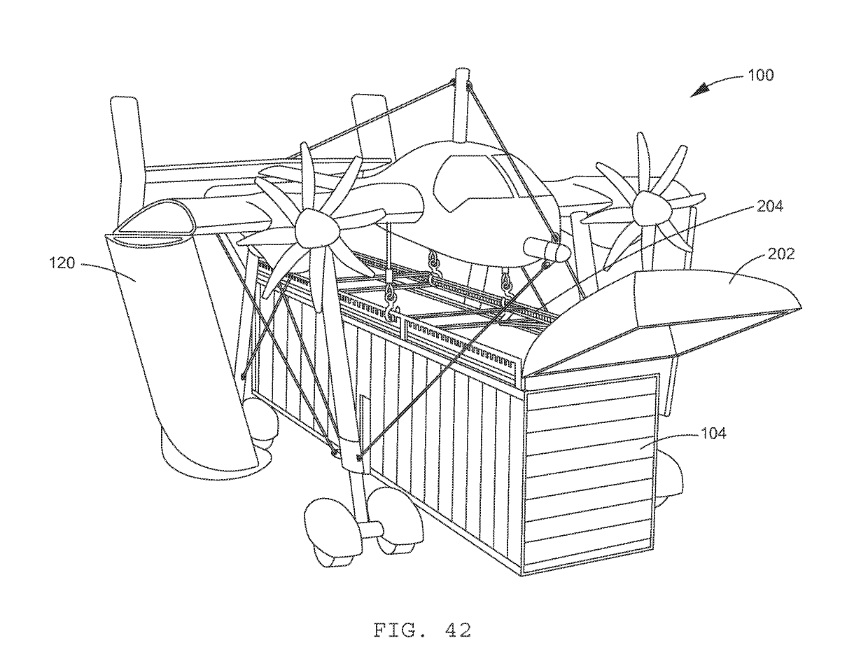

FIG. 40 is a perspective view of aircraft 100 in a stand-by position showing the container 104 on the surface coupled to top lift payload interface system 102. As shown in FIG. 40, latches 130 are upright, fairing 202 is open and portions of wings 120 are folded down.

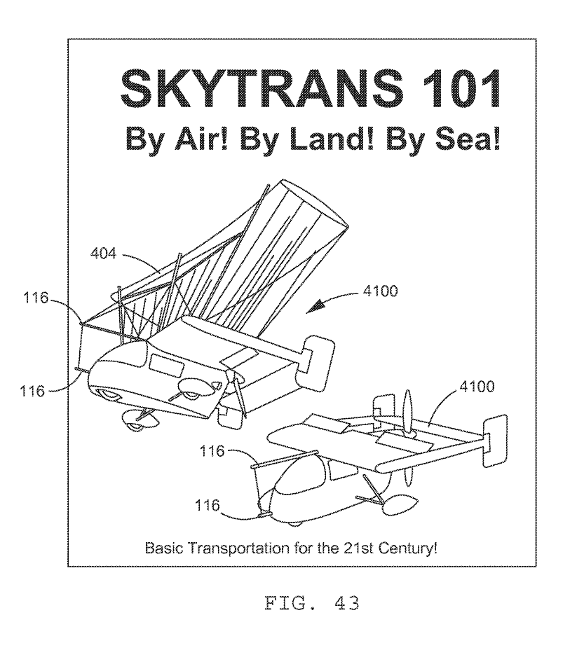

FIG. 41 show perspective views of aircraft 4100 with convertible para-wing 404. As shown in FIG. 41, the para-wing 404 may be used with a scaled-down personal-sized aircraft, such as a personal air vehicle (e.g., a 2-person aircraft) 4100 to transport people. As shown in FIG. 41, in one embodiment, the personal air vehicle 4100 may include prow masts 116 and a cable extending between the prow masts 116 to stabilize the para wing 404 when in flight. In some embodiments, the prow masts 116 may be removable and not used when the personal air vehicle 4100 is on the ground. In some embodiments, personal air vehicle 4100 may not include any prow masts.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention.

What is claimed is:

1. A convertible payload transport aircraft comprising:
a main body including a cockpit;
a first fixed wing extending in a first direction from a side of the cockpit;
a second fixed wing extending in a second direction from an opposing side of the cockpit;
a first pair of wheel struts extending between the first fixed wing and a first set of corresponding wheels;
a second pair of wheel struts extending between the second fixed wing and a second set of corresponding wheels;
a plurality of wheel-strut cables that extend between the first pair of wheel struts, the second pair of wheel struts and the main body; and
a payload interface system disposed under the cockpit and between the first pair of wheel struts and the second pair of wheel struts and configured to be coupled to a payload.

2. The convertible payload transport aircraft according to claim 1, further comprising:
a mast system comprising:
a main front fixed para-wing mast extending from a top of the main body,
a first side front fixed para-wing mast extending from a top of the first fixed wing;
a second side front fixed para-wing mast extending from a top of the second fixed wing;
a first mast spacer extending between the main front fixed para-wing mast and the first side front fixed para-wing mast;
a second mast spacer extending between the main front fixed para-wing mast and the second side front fixed para-wing mast;
a first rear moveable para-wing mast extending from a top of the first fixed wing;
a second rear moveable para-wing mast extending from a top of the second fixed wing;
a plurality of mast cables configured to secure the mast system to the main body; and
a para-wing coupled to the mast system and configured to facilitate transport of the payload.

3. The convertible payload transport aircraft according to claim 2, wherein the para-wing further comprises:
upper and lower fabric surfaces;
a plurality of flexible ribs extending between the upper and lower fabric surfaces;
a plurality of rigid ribs extending between the upper and lower fabric surfaces;
a plurality of pockets, each of the pockets configured to hold one of the plurality of rigid ribs;
leading edge ram-air inflation ports;
a plurality of riser lines and mast coupling elements configured to couple the para-wing to the mast system; and
internal spar-rod rib spacers configured to space the plurality of rigid ribs apart from each other.

4. The convertible payload transport aircraft according to claim 1, wherein the payload interface system is a top lift payload interface system comprising:
a plurality of movable engaging elements extending from the main body; and
a rack comprising:
a plurality of cross supports, each cross support extending a width between the first pair of wheel struts and the second pair of wheel struts;
a pair of opposing side supports, each side support extending a length substantially perpendicular to the width; and
a plurality of teeth spaced from each other and extending from the pair of opposing side supports, wherein the plurality of teeth are configured to receive the plurality of engaging elements within spaces between the plurality of teeth,
wherein the plurality of movable engaging elements are configured to lower the rack from the main body and raise the rack toward the main body.

5. The convertible payload transport aircraft according to claim 4, wherein the top lift payload interface system is configured to adjust the payload along the length of the pair of opposing side supports.

6. The convertible payload transport aircraft according to claim 4, further comprising:
a first fairing disposed at one end of the rack;
a second fairing disposed at an opposite end of the rack,
wherein the fairings are configured to: (i) open to facilitate loading and unloading of the payload; and (ii) close to facilitate enhanced aerodynamics during flight.

7. The convertible payload transport aircraft according to claim 4, wherein the top lift payload interface system further comprises a container engagement system configured to secure the payload to the rack.

8. The convertible payload transport aircraft according to claim 1, wherein the payload interface system is a drive-through payload interface system comprising:
a plurality of movable engaging elements extending from the main body; and
a payload holding compartment configured to receive the payload, the payload holding compartment comprising:
a top rack having: (i) a plurality of cross supports extending a width between the first pair of struts and the second pair of struts; (ii) a pair of opposing side supports extending a length substantially perpendicular to the width; and (iii) a plurality of teeth spaced from each other, extending from the pair of opposing side supports and configured to receive the plurality of engaging elements extending from the main body to secure the payload to the main body;
a cargo deck having: (i) a plurality of cross supports extending a width between the first pair of struts and the second pair of struts; and (ii) a pair of opposing side supports extending a length substantially perpendicular to the width; and
a pair of opposing side walls extending between the top rack and the cargo deck,
wherein the plurality of movable engaging elements are configured to lower the payload holding compartment from the main body and raise the payload holding compartment toward the main body.

9. The convertible payload transport aircraft according to claim 8, wherein the payload holding compartment further comprises a main compartment body and expandable bellows disposed at opposing ends of the main compartment body, the expandable bellows configured to expand and retract to facilitate payloads of different sizes.

10. The convertible payload transport aircraft according to claim 8, wherein the payload holding compartment further comprises:
a first fairing disposed at one end of the payload holding compartment; and
a second fairing disposed at an opposite end of the payload holding compartment,
wherein the fairings are configured to: (i) open to facilitate loading of the payload into the holding compartment and unloading of the payload from the payload holding compartment; and (ii) close to provide aerodynamics.

11. The convertible payload transport aircraft according to claim 8, wherein the payload holding compartment further comprises a plurality of columns extending between the top rack and the cargo deck and configured to provide load paths to distribute a load exerted by the payload from the cargo deck to the top rack.

12. The convertible payload transport aircraft according to claim 11, further comprising a plurality of riser lines coupled between the plurality of rigid ribs and the first wing and between the plurality of rigid ribs and the second fixed wing.

13. The convertible payload transport aircraft according to claim 1, further comprising pivotable latches coupled to the first pair of wheel struts and the second pair of wheel struts and configured to pivot between upright standby positions and engaged locked positions to limit or prevent movement of the payload.

14. A convertible payload transport aircraft comprising:
a main body including a cockpit;
a pair of fixed wings extending in opposite directions from the cockpit;
a plurality of wheel struts extending between the pair of fixed wings and corresponding wheels;
a top lift payload interface system disposed under the cockpit and configured to be coupled to a payload, the payload interface system comprising:
a plurality of movable engaging elements extending from the main body; and
a rack having: (i) a plurality of cross supports extending widthwise; (ii) a pair of opposing side supports extending lengthwise substantially perpendicular to the width; and (iii) a plurality of teeth spaced from each other and extending from the pair of opposing side supports,
wherein the plurality of teeth are configured to receive the plurality of engaging elements within spaces between the plurality of teeth and the plurality of movable engaging elements are configured to lower the rack from the main body and raise the rack toward the main body.

15. The convertible payload transport aircraft according to claim 14, wherein top lift payload interface system is configured to adjust the payload along the length of the pair of opposing side supports.

16. The convertible payload transport aircraft according to claim 14, further comprising:
a first fairing disposed at one end of the rack;
a second fairing disposed at an opposite end of the rack,
wherein the first fairing and the second fairing are configured to: (i) open to facilitate loading and unloading of the payload; and (ii) close to facilitate enhanced aerodynamics during flight.

17. The convertible payload transport aircraft according to claim 14, wherein the top lift payload interface system further comprises a container engagement system configured to secure the payload to the rack.

18. A convertible payload transport aircraft comprising:
a main body including a cockpit;
a pair of fixed wings extending in opposite directions from the cockpit;
a plurality of wheel struts extending between the pair of wings and corresponding wheels;
a drive-through payload interface system disposed under the cockpit and configured to be coupled to a payload, the payload interface system comprising:
a plurality of movable engaging elements extending from the main body; and
a drive through payload holding compartment configured to receive the payload, the drive through payload holding compartment comprising:
a top rack having: (i) a plurality of cross supports extending a width between the first pair of wheel struts and the second pair of wheel struts; (ii) a pair of opposing side supports extending a length substantially perpendicular to the width; and (iii) a plurality of teeth spaced from each other, extending from the pair of opposing side supports and configured to receive the plurality of engaging elements extending from the main body to secure the payload to the main body;
a cargo deck having: (i) a plurality of cross supports extending a width between the first pair of wheel struts and the second pair of wheel struts; and (ii) a pair of opposing side supports extending a length substantially perpendicular to the width; and
a pair of opposing side walls extending between the top rack and the cargo deck,
wherein the plurality of movable engaging elements are configured to lower the payload holding compartment from the main body and raise the payload holding compartment toward the main body.

19. The convertible payload transport aircraft according to claim 18, further comprising:
a mast system comprising:
a main front fixed para-wing mast extending from a top of the main body,
a first side front fixed para-wing mast extending from a top of one of the pair of fixed wing;
a second side front fixed para-wing mast extending from a top of another of the pair of fixed wing;
a first rear moveable para-wing mast extending from a top of the one fixed wing;
a second rear moveable para-wing mast extending from a top of the other fixed wings;
a plurality of mast cables configured to secure the mast system to the main body; and
a para-wing coupled to the mast system and configured to facilitate transport of the payload.

20. The convertible payload transport aircraft according to claim 19, wherein the para-wing further comprises:
upper and lower fabric surfaces;
a plurality of flexible ribs extending between the upper and lower fabric surfaces;
a plurality of rigid ribs extending between the upper and lower fabric surfaces;
a plurality of pockets, each of the pockets configured to hold one of the plurality of rigid ribs;
leading edge ram-air inflation ports;
a plurality of riser lines and mast coupling elements configured to couple the para-wing to the mast system; and
internal spar-rod rib spacers configured to space the plurality of ribs apart from each other.
